(19) United States
(12) Patent Application Publication
(10) Pub. No.: US 2023/0296738 A1
(43) Pub. Date: Sep. 21, 2023

(54) DISTANCE MEASUREMENT DEVICE, DISTANCE MEASUREMENT METHOD, AND PHASE DETECTION DEVICE

(71) Applicant: Panasonic Intellectual Property Management Co., Ltd., Osaka (JP)

(72) Inventor: YUSUKE OKADA, Osaka (JP)

(21) Appl. No.: 18/321,928

(22) Filed: May 23, 2023

Related U.S. Application Data
(63) Continuation of application No. PCT/JP2021/035123, filed on Sep. 24, 2021.

(30) Foreign Application Priority Data
Dec. 23, 2020 (JP) 2020-213650
Sep. 6, 2021 (JP) 2021-144421

(51) Int. Cl. G01S 7/4861; G01S 7/481; G01S 17/10; G01S 7/4865

(52) U.S. Cl. CPC G01S 7/4861; G01S 7/4816; G01S 17/10; G01S 7/4865

(57) ABSTRACT

A distance measurement device includes a light source that projects pulse light toward an object, a detector that receives reflected light of the projected pulse light from the object, the detector including a first pixel having sensitivity that is variable, and a control unit. The light source projects first pulse light in a first period. The control unit sets the sensitivity of the first pixel to sensitivity α₁ in a second period and sets the sensitivity of the first pixel to sensitivity α₂ different from the sensitivity α₁ in a third period following the second period. A length of the second period is equal to a length of the first period. A start time of the second period is after a start time of the first period. The second period and the third period are included in a first light-reception period.

### BACKGROUND

### 1. Technical Field

The present disclosure relates to a distance measurement device, a distance measurement method, and a phase detection device.

### 2. Description of the Related Art

Recently, a method of calculating the distance to an object by projecting infrared light onto the object and receiving light reflected from the object with an image capturing device has been proposed. Since the speed of light is known, it is possible to measure the distance to a target object by projecting pulse light from a light source toward the target object, receiving reflected light from the target object, and measuring a delay time of the pulse light, that is, the time of flight of the pulse light. A time-of-flight (TOF) method is a method of measuring the distance to a target object by measuring the time of flight of pulse light. In this manner, distance is measured by using a device configured to detect a phase difference that represents a delay time from a reference time.

This principle is exploited in, for example, a technology proposed in Japanese Unexamined Patent Application Publication No. 2004-294420 to acquire a two-dimensional distance image by using a complementary metal oxide semiconductor (CMOS) solid-state image capturing device having a pixel structure of a charge distribution scheme. Specifically, when reflected pulse light arrives with delay after projected pulse light is reflected by an object, a signal component corresponding to the preceding part of the reflected pulse light and a signal component corresponding to the following part thereof are distributed by a switch. It is possible to obtain distance information for each pixel by detecting the distributed signal components for each pixel and calculating the ratio of the preceding and following parts.

### SUMMARY

One non-limiting and exemplary embodiment provides a distance measurement device and a distance measurement method that can increase the accuracy of distance measurement. One non-limiting and exemplary embodiment also provides a phase detection device that can increase the accuracy of phase detection.

In one general aspect, the techniques disclosed here feature a distance measurement device including a projector that projects pulse light toward an object, a detector that receives reflected light of the pulse light from the object, the detector including a first pixel having sensitivity that is variable, and a control circuit. The projector projects first pulse light in a first period. The control circuit sets the sensitivity of the first pixel to first sensitivity in a second period and sets the sensitivity of the first pixel to second sensitivity different from the first sensitivity in a third period following the second period, a length of the second period being equal to a length of the first period, a start time of the second period being after a start time of the first period, the second period and the third period being included in a first light-reception period.

According to the aspect of the present disclosure, it is possible to increase the accuracy of distance measurement. In addition, according to the aspect of the present disclosure, it is possible to increase the accuracy of phase detection.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A is a sectional view illustrating an exemplary pixel of an image capturing element in a distance measurement device configured to perform distance measurement by a TOF scheme according to the related art;

FIG. 1B is a diagram illustrating exemplary pixel operation in the TOF scheme of the related art;

FIG. 2 is a block diagram illustrating an exemplary configuration of a distance measurement device according to Embodiment 1;

FIG. 3 is a diagram illustrating an exemplary circuit configuration of an image capturing device according to Embodiment 1;

FIG. 4 is a sectional view schematically illustrating an exemplary device structure of a pixel according to Embodiment 1;

FIG. 5 is a timing chart illustrating exemplary operation of the distance measurement device according to Embodiment 1;

FIG. 6 is a timing chart illustrating exemplary operation of a plurality of pixels according to Embodiment 1;

FIG. 7 is a timing chart illustrating exemplary timings of control signals in a pixel reading period according to Embodiment 1;

FIG. 8 is a diagram for description of the principle of measurement of the distance to an object by the distance measurement device according to Embodiment 1;

FIG. 9 is another diagram for description of the principle of measurement of the distance to the object by the distance measurement device according to Embodiment 1;

FIG. 10 is a timing chart illustrating a case in which the operation illustrated in FIG. 5 is repeated;

FIG. 11 is a timing chart illustrating Modification 1 of the operation of the distance measurement device according to Embodiment 1;

FIG. 12A is a diagram illustrating the amount of signal charge of reflected light accumulated in the distance measurement device when projection light is projected onto the object;

FIG. 12B is a diagram illustrating the amount of signal charge of reflected light accumulated in the distance measurement device when projection light having a pulse width different from that in FIG. 12A is projected onto the object;

FIG. 13 is a timing chart illustrating Modification 2 of the operation of the distance measurement device according to Embodiment 1;

FIG. 14 is a timing chart illustrating Modification 3 of the operation of the distance measurement device according to Embodiment 1;

FIG. 15 is a diagram illustrating an exemplary circuit configuration of an image capturing device according to Embodiment 2;

FIG. 16 is a timing chart illustrating exemplary operation of a distance measurement device according to Embodiment 2;

FIG. 17 is a diagram illustrating an exemplary circuit configuration of an image capturing device according to Embodiment 3;

FIG. 18 is a timing chart illustrating exemplary operation of a distance measurement device according to Embodiment 3;

FIG. 19 is a timing chart illustrating a modification of the operation of the distance measurement device according to Embodiment 3;

FIG. 20 is a diagram illustrating an exemplary circuit configuration of an image capturing device according to Embodiment 4;

FIG. 21 is a timing chart illustrating exemplary operation of a distance measurement device according to Embodiment 4;

FIG. 22 is a block diagram illustrating an exemplary configuration of a phase detection device according to Embodiment 5;

FIG. 23 is a diagram illustrating exemplary signals sent from a transmission device; and

FIG. 24 is a timing chart illustrating exemplary operation of the phase detection device according to Embodiment 5.

### DETAILED DESCRIPTIONS

Background to Aspect of Present Disclosure

Before the detailed description of embodiments of the present disclosure, a distance measurement method of the TOF scheme according to the related art will be described below.

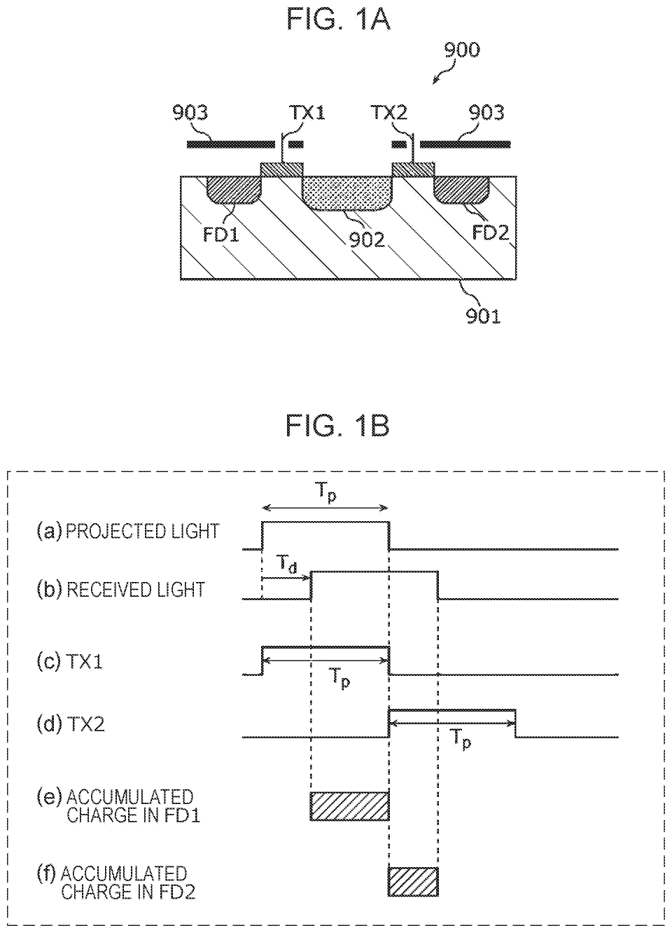

FIG. 1A is a sectional view illustrating an exemplary pixel 900 of an image capturing element in a distance measurement device configured to perform distance measurement by the TOF scheme of the related art. As illustrated in FIG. 1A, the pixel 900 includes a photodiode 902, a charge accumulation part FD1, and a charge accumulation part FD2 on a semiconductor substrate 901, which are connected through a gate controlled by a control signal line TX1 and a control signal line TX2. Any part other than the photodiode 902 is shielded by a light-shielding plate 903. Although not illustrated in FIG. 1A, the distance measurement device configured to perform distance measurement of the TOF scheme includes a light source for irradiating an object with light, a lens for imaging reflected light from the object onto the pixel 900, and the like in addition to the image capturing element including the pixel 900.

FIG. 1B is a diagram illustrating exemplary operation of the pixel 900 in the TOF scheme according to the related art. In the example illustrated in FIG. 1B, pulse light having a pulse width Tₚ is projected from the light source onto the object at a timing indicated as “projected light” in FIG. 1B, and reflected light from the object is incident on the pixel 900 at a timing indicated as “received light” in FIG. 1B, in other words, is incident on the pixel 900 as pulse light having the pulse width Tₚ and delayed from the projected light by a flight time T_{d}. In the pixel 900, electric charge generated when the reflected light is photoelectrically converted at the photodiode 902 is distributed and accumulated in the two charge accumulation parts FD1 and FD2. More specifically, as illustrated in “TX1”, “TX2”, “electric charge accumulated in FD1”, and “electric charge accumulated in FD2” in FIG. 1B, electric charge generated at the photodiode 902 by the reflected light is accumulated in the charge accumulation part FD1 in a period in which the voltage of the control signal line TX1 is at “High” level, and is accumulated in the charge accumulation part FD2 in a period in which the voltage of the control signal line TX2 is at “High” level.

As illustrated in FIG. 1B, the voltage of the control signal line TX1 is at “High” level in a period from a time point at which irradiation with the projected light starts to a time point at which the irradiation with the projected light ends. The voltage of the control signal line TX2 is at “High” level in a period from the time point at which the irradiation with the projected light ends to a time point by which the pulse width Tₚ of the projected light has elapsed. Accordingly, the amount of electric charge corresponding to electric charge generated in the time width of “Tₚ−T_{d}” in the pulse width Tₚ of the reflected light is accumulated in the charge accumulation part FD1, and the amount of electric charge corresponding to electric charge generated in the time width of the flight time T_{d} is accumulated in the charge accumulation part FD2. When A₁ represents a signal read from the charge accumulation part FD1 by a reading circuit (not illustrated) and A₂ represents a signal read from the charge accumulation part FD2, the delay time of the reflected light, which represents the phase difference between the projected light and the reflected light, in other words, the flight time T_{d} of the pulse light is calculated by Expression (1) below.

$${T}_{d} = \frac{{A}_{2}}{{A}_{1} + {A}_{2}} {T}_{p} \qquad ( 1 )$$

A distance d to the object can be calculated by Expression (2) below from the flight time T_{d} obtained by Expression (1).

$$d = \frac{{cT}_{d}}{2} \qquad ( 2 )$$

In the expression, c represents the speed of light (c=3×10⁸ m/s). In this manner, although the distance d to the object can be calculated by using the pixel 900, electric charge generated by the one photodiode 902 needs to be distributed in the charge accumulation parts FD1 and FD2 at high speed in accordance with the pulse width Tₚ in the pixel 900. Furthermore, electric charge generated by the photodiode 902 may be distributed and accumulated in the charge accumulation part FD2 before being completely transferred to the charge accumulation part FD1. Thus, it is difficult to increase the accuracy of distance measurement by the TOF scheme of the related art.

In Expression (2), an upper limit dₘₐₓ of distance measurable by the scheme corresponds to a case in which the flight time T_{d} is equal to the pulse width Tₚ of the projected light in Expression (1), and is calculated by Expression (3) below.

$${d}_{max} = \frac{{cT}_{p}}{2} \qquad ( 3 )$$

As understood from Expression (3), the upper limit dₘₐₓ of measurable distance is proportional to the pulse width Tₚ of the projected light, and it is possible to increase the range of distance measurement by increasing the pulse width Tₚ. However, it is known that, as the pulse width Tₚ increases, the resolution of distance measurement decreases and the accuracy of distance measurement decreases. In other words, the size of the range of distance measurement and the measurement resolution have a trade-off relation in the TOF scheme of the related art, and it is difficult to excellently maintain both.

To solve such a problem, the inventors have found that it is possible to increase the accuracy of phase detection and the accuracy of distance measurement by controlling pixel sensitivity. For example, one aspect of a distance measurement device in the present disclosure is a distance measurement device of the TOF scheme, which can increase the range of distance measurement without causing degradation of measurement resolution. Detailed description thereof will be provided below.

### Outline of Present Disclosure

An outline of an aspect of the present disclosure is as follows.

A distance measurement device according to an aspect of the present disclosure includes a projector that projects pulse light toward an object, a detector that receives reflected light of the pulse light from the object, the detector including a first pixel having sensitivity that is variable, and a control circuit. The projector projects first pulse light in a first period. The control circuit sets the sensitivity of the first pixel to first sensitivity in a second period and sets the sensitivity of the first pixel to second sensitivity different from the first sensitivity in a third period following the second period, a length of the second period being equal to a length of the first period, a start time of the second period being after a start time of the first period, the second period and the third period being included in a first light-reception period.

In this manner, since the sensitivity of the first pixel changes between the first sensitivity and the second sensitivity in the first light-reception period, the amount of signal charge accumulated in the first pixel changes in accordance with the flight time of the first pulse light. As a result, the flight time can be calculated from the amount of signal charge accumulated in the first pixel, and thus the distance to the object can be measured by the TOF scheme. In such distance measurement, for example, it is not needed to distribute signal charge to two charge accumulation parts as in the related art, and thus decrease of the accuracy of distance measurement due to incomplete distribution of signal charge does not occur. Accordingly, the distance measurement device according to the present aspect has increased accuracy of distance measurement.

For example, the first sensitivity and the second sensitivity may be constant in the second period and the third period, respectively.

In this manner, since the first sensitivity and the second sensitivity are constant, the flight time can be easily calculated from the amount of electric charge accumulated in the first pixel.

For example, the first sensitivity and the second sensitivity may linearly increase in the second period and the third period respectively or may linearly decrease in the second period and the third period respectively.

In this manner, since the first sensitivity and the second sensitivity linearly change, the flight time can be easily calculated from the amount of electric charge accumulated in the first pixel.

For example, the first light-reception period may include the second period, the third period, and a fourth period following the third period, the control circuit may set the sensitivity of the first pixel to third sensitivity in the fourth period, the third sensitivity being different from the first sensitivity and the second sensitivity, a length of the third period may be equal to the length of the first period, and the second sensitivity may be sensitivity between the first sensitivity and the third sensitivity.

In this manner, since the sensitivity of the first pixel in the first light-reception period changes with increase or decrease to the first sensitivity, the second sensitivity, and the third sensitivity in the stated order, the amount of signal charge accumulated in the first pixel changes in accordance with the flight time of pulse light. The first light-reception period is longer than twice of the first period in which the first pulse light is projected, in other words, twice of the pulse width of the first pulse light. As a result, the flight time can be calculated from the amount of signal charge accumulated in the first pixel even in a case of the distance to the object by which the flight time is longer than the pulse width, and thus the distance to the object can be measured by the TOF scheme. Thus, it is possible to increase the range of measurement of the distance to the object without increasing the pulse width, thereby preventing decrease of the accuracy of distance measurement due to increase of the pulse width. Accordingly, the distance measurement device has increased accuracy of distance measurement.

For example, the first sensitivity, the second sensitivity, and the third sensitivity may be constant in the second period, the third period, and the fourth period, respectively.

In this manner, since the first sensitivity, the second sensitivity, and the third sensitivity are constant, the flight time can be easily calculated from the amount of electric charge accumulated in the first pixel.

For example, in the first light-reception period, the first sensitivity, the second sensitivity, and the third sensitivity may linearly increase in the second period, the third period, and the fourth period respectively or may linearly decrease in the second period, the third period, and the fourth period respectively.

In this manner, since the first sensitivity, the second sensitivity, and the third sensitivity linearly change, the flight time can be easily calculated from the amount of electric charge accumulated in the first pixel.

For example, the detector may include a second pixel, and the control circuit may set, in the first light-reception period, sensitivity of the second pixel to reference sensitivity for distance measurement.

In this manner, signal charge based on the reference sensitivity is accumulated in the second pixel. As a result, the flight time can be calculated based on the sensitivity ratio of the first pixel and the second pixel, which can be more accurately measured than the absolute value of sensitivity, the amount of signal charge accumulated in the first pixel, and the amount of signal charge accumulated in the second pixel. Accordingly, the distance measurement device has increased accuracy of distance measurement.

For example, the detector may include a third pixel, the control circuit may set, in a non-light-reception period following the first light-reception period, the sensitivity of the first pixel to basis sensitivity lower than the sensitivity of the first pixel in the first light-reception period, and the control circuit may set sensitivity of the third pixel to the basis sensitivity in the first light-reception period.

In this manner, the sensitivity of the third pixel is set to the basis sensitivity of the first pixel in the non-light-reception period. Accordingly, even when signal charge is accumulated in the first pixel in the non-light-reception period in which signal charge is not to be accumulated, influence of the amount of signal charge accumulated in the first pixel in the non-light-reception period on the accuracy of distance measurement can be reduced by subtracting the amount of signal charge accumulated in the third pixel.

For example, the projector may project second pulse light in a fifth period having a length equal to the length of the first period, and the control circuit may set the sensitivity of the first pixel to reference sensitivity for distance measurement in a second light-reception period, a length of the second light-reception period being equal to a length of the first light-reception period, a start time of the second light-reception period being after a start time of the fifth period.

In this manner, signal charge based on the reference sensitivity is accumulated in the first pixel in the second light-reception period. As a result, the flight time can be calculated based on the ratio of the sensitivity of the first pixel in the first light-reception period and the sensitivity of the first pixel in the second light-reception period, which can be more accurately measured than the absolute value of the sensitivity of the first pixel, and the amount of signal charge accumulated in the first pixel in the first light-reception period and the amount of signal charge accumulated in the first pixel in the second light-reception period. Accordingly, the distance measurement device has increased accuracy of distance measurement.

For example, the projector may project third pulse light in a sixth period having a length equal to the length of the first period, the control circuit may set, in a non-light-reception period following the first light-reception period, the sensitivity of the first pixel to basis sensitivity lower than the sensitivity of the first pixel in the first light-reception period, and the control circuit may set the sensitivity of the first pixel to the basis sensitivity in a third light-reception period, a length of the third light-reception period being equal to a length of the first light-reception period, a start time of the third light-reception period being after a start time of the sixth period.

In this manner, the sensitivity of the first pixel in the third light-reception period is set to the basis sensitivity of the first pixel in the non-light-reception period. Accordingly, even when signal charge is accumulated in the first pixel in the non-light-reception period in which signal charge is not to be accumulated, influence of the amount of signal charge accumulated in the first pixel in the non-light-reception period on the accuracy of distance measurement can be reduced by subtracting the amount of signal charge accumulated in the first pixel in the third light-reception period.

For example, the first pixel may include a photoelectrical convertor, and the control circuit may set the sensitivity of the first pixel by adjusting a magnitude of voltage applied to the photoelectrical convertor.

In this manner, since the sensitivity of the first pixel is set only by adjusting the magnitude of voltage applied to the photoelectrical convertor, sensitivity setting operation can be simplified.

For example, the first pixel may include a photoelectrical convertor, and the control circuit may set the sensitivity of the first pixel by adjusting a duty cycle of pulse voltage that is applied to the photoelectrical convertor and that alternately repeats first voltage and second voltage larger than the first voltage.

In this manner, since the sensitivity of the first pixel is proportional to the duty cycle, the sensitivity of the first pixel can be easily adjusted to desired sensitivity.

A distance measurement method according to an aspect of the present disclosure includes projecting first pulse light toward an object in a first period, detecting reflected light of the first pulse light from the object at first sensitivity in a second period, and detecting the reflected light of the first pulse light from the object at second sensitivity different from the first sensitivity in a third period following the second period, a length of the second period being equal to a length of the first period, a start time of the second period being after a start time of the first period, the second period and the third period being included in a first light-reception period.

In this manner, since the sensitivity of detection changes between the first sensitivity and the second sensitivity in the first light-reception period, a detected signal amount changes in accordance with the flight time of pulse light. As a result, the flight time can be calculated from the detected signal amount, and thus the distance to the object can be measured by the TOF scheme. In such distance measurement, for example, it is not needed to distribute signal charge to two parts for detection as in the related art, and thus accuracy decrease due to incomplete distribution of signal charge does not occur. Accordingly, the distance measurement method according to the present aspect has increased accuracy of distance measurement.

For example, the distance measurement method may further include detecting, in the first light-reception period, the reflected light at reference sensitivity for distance measurement.

In this manner, a signal can be detected based on the reference sensitivity. As a result, the flight time can be calculated based on the sensitivity ratio of each of the first sensitivity and the second sensitivity and the reference sensitivity, which can be more accurately measured than the absolute value of sensitivity, a signal amount detected at the first sensitivity and the second sensitivity, and a signal amount detected at the reference sensitivity. Accordingly, the distance measurement method has increased accuracy of distance measurement.

For example, the distance measurement method may further include projecting second pulse light toward the object in a fifth period having a length equal to the length of the first period, and detecting reflected light of the second pulse light from the object at reference sensitivity for distance measurement in a second light-reception period, a length of the second light-reception period being equal to a length of the first light-reception period, a start time of the second light-reception period being after a start time of the fifth period.

In this manner, a signal can be detected based on the reference sensitivity in the second light-reception period. As a result, the flight time can be calculated based on the ratio of sensitivity in the first light-reception period and sensitivity in the second light-reception period, which can be more accurately measured than the absolute value of sensitivity, a signal amount detected in the first light-reception period, and a signal amount detected in the second light-reception period. Accordingly, the distance measurement method has increased accuracy of distance measurement.

A phase detection device according to an aspect of the present disclosure includes a detector that receives pulse light delayed for a predetermined time from a reference time, the detector including a first pixel having sensitivity that is variable, and a control circuit. The control circuit sets the sensitivity of the first pixel to first sensitivity in a second period and sets the sensitivity of the first pixel to second sensitivity different from the first sensitivity in a third period following the second period, a length of the second period being equal to a pulse width of the pulse light, a start time of the second period being after the reference time, the second period and the third period being included in a first light-reception period.

In this manner, since the sensitivity of the first pixel changes between the first sensitivity and the second sensitivity in the first light-reception period, the amount of signal charge accumulated in the first pixel changes in accordance with the delay time of the pulse light from the reference time. As a result, a phase difference that represents the delay time from the reference time can be detected based on the amount of signal charge accumulated in the first pixel. In such phase detection, for example, it is not needed to distribute signal charge to two charge accumulation parts as in the related art, and thus decrease of the accuracy of phase detection due to incomplete distribution of signal charge does not occur. Accordingly, the phase detection device according to the present aspect has increased accuracy of phase detection.

Embodiments of the present disclosure will be described below with reference to the accompanying drawings. Each embodiment described below is a comprehensive or specific example. For example, numerical values, shapes, materials, constituent components, the forms of disposition and connection of constituent components, steps, the order of steps described below in the embodiments are merely exemplary and not intended to limit the present disclosure. Various kinds of aspects described in the present specification may be combined without inconsistency. Among constituent components in the embodiments below, any constituent component not written in an independent claim is described as an optional constituent component. In the following description, constituent components having functions substantially identical to each other are denoted by the same reference sign and duplicate description thereof is omitted in some cases.

In the present specification, any term describing the relation between components, any term describing the shape of a component, and any numerical value range are not expressions only indicating strict meanings but are expressions meaning inclusion of substantially equivalent ranges with, for example, the difference of several % approximately.

### Embodiment 1

First, Embodiment 1 will be described below. Embodiment 1 will be described for a distance measurement device configured to perform distance measurement by the TOF scheme.

### Overall Configuration of Distance Measurement Device

A distance measurement device in the present disclosure measures the distance from the distance measurement device to an object by the TOF scheme, in other words, by measuring the flight time of pulse light having a predetermined width in a round trip to the object based on an electric signal obtained by irradiating the object with the pulse light and photoelectrically converting the pulse light reflected from the object. Each pixel of a light receiving element of the distance measurement device has a function to change light receiving sensitivity by, for example, changing voltage applied to the light receiving element. The light receiving sensitivity of each pixel at part of the light receiving element is set to, for example, increase by a predetermined ratio at each elapse of a time corresponding to the pulse width of the pulse light since a time point after a time point at which irradiation of the object with the pulse light starts. The pulse light reflected by the object is photoelectrically converted by a pixel provided with such light receiving sensitivity setting, and the flight time of the pulse light between a light source and the object is calculated from a signal that is output upon the photoelectric conversion. Thereafter, the distance to the object is calculated from the calculated flight time. In the present specification, light receiving sensitivity is also simply referred to as “sensitivity”.

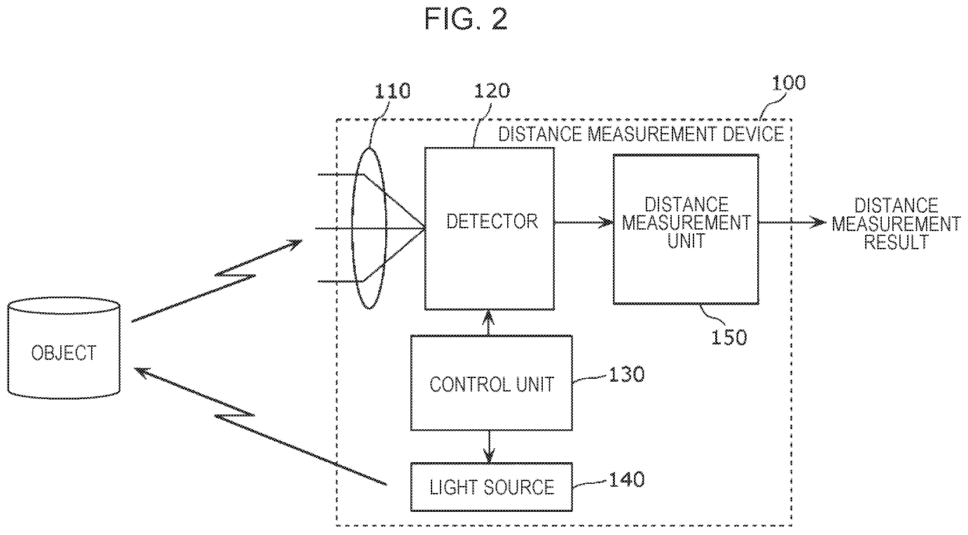

FIG. 2 is a block diagram illustrating an exemplary configuration of a distance measurement device according to the present embodiment. As illustrated in FIG. 2, a distance measurement device 100 according to the present embodiment includes a lens optical system 110, a detector 120, a control unit 130, a light source 140, and a distance measurement unit 150.

The lens optical system 110 includes, for example, a lens and an aperture. The lens optical system 110 condenses light onto a light-receiving surface of the detector 120.

The detector 120 receives reflected light of pulse light projected by the light source 140 from the object. The detector 120 is, for example, an image capturing device. For example, the detector 120 converts light incident through the lens optical system 110 into an electric signal in accordance with the intensity of the light and outputs the electric signal as image data. The detector 120 has a function to change light receiving sensitivity by, for example, changing applied voltage through external control. The following description will be mainly made for a case in which the detector 120 is an image capturing device. Detailed description of the configuration of the detector 120 will be provided later.

The control unit 130 generates signals for controlling the detector 120 and the light source 140 and supplies the generated signals to the detector 120 and the light source 140. The control unit 130 is an exemplary control circuit. More specifically, the control unit 130 controls the detector 120 and the light source 140 such that the detector 120 performs image capturing operation based on the timing of light irradiation by the light source 140. In addition, the control unit 130 performs control to adjust the light receiving sensitivity of the detector 120 as described above. The control unit 130 is implemented by, for example, a micro controller including one or more processors with built-in computer programs. Functions of the control unit 130 may be implemented by combination of a general-purpose processing circuit and software or may be implemented by hardware specialized for processing at the control unit 130.

The light source 140 projects pulse light toward the object. Specifically, the light source 140 irradiates the object with the pulse light at a predetermined timing controlled by the control unit 130. The pulse light is, for example, infrared light. The light source 140 is an exemplary projector. The light source 140 may be any well-known light source configured to emit infrared light as the pulse light and is, for example, a laser diode light source configured to emit infrared light.

The distance measurement unit 150 calculates the distance to the object based on an output signal from the detector 120 and outputs data of the calculated distance and the like from the distance measurement device 100. Specifically, the distance measurement unit 150 calculates the flight time of the pulse light based on, for example, the output signal from the detector 120 by using expressions to be described later. The distance measurement unit 150 calculates the distance to the object based on the calculated flight time by using Expression (2) above. The distance measurement unit 150 may output flight time data in place of distance data. The distance measurement unit 150 is implemented by, for example, a micro controller including one or more processors with built-in computer programs. Functions of the distance measurement unit 150 may be implemented by combination of a general-purpose processing circuit and software or may be implemented by hardware specialized for processing at the distance measurement unit 150.

The distance measurement device 100 does not necessarily need to include the distance measurement unit 150, and the detector 120 may output the output signal to the outside.

### Circuit Configuration of Detector

A circuit configuration of the detector 120 will be described below. The description will be made for a case in which the detector 120 is an image capturing device 120A.

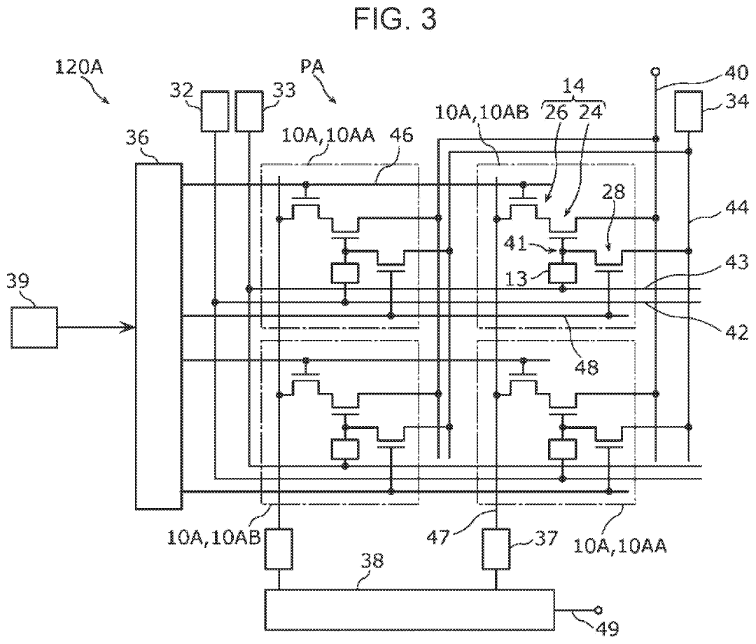

FIG. 3 is a diagram illustrating an exemplary circuit configuration of the image capturing device 120A according to the present embodiment. The image capturing device 120A illustrated in FIG. 3 includes a pixel array PA of a plurality of pixels 10A that are two-dimensionally arrayed. The pixels 10A includes at least one pixel 10AA and at least one pixel 10AB. For example, the pixel 10AA and the pixel 10AB are disposed adjacent to each other as one set of pixels. The pixel 10AA is an exemplary first pixel, and the pixel 10AB is an exemplary second pixel. The pixel 10AA is a variable sensitivity pixel having sensitivity that is set to be variable in a charge accumulation period to be described later, and the pixel 10AB is a fixed sensitivity pixel having sensitivity fixed and set to constant reference sensitivity in the charge accumulation period. In the following description, the pixel 10AA and the pixel 10AB are collectively referred to as pixels 10A in some cases when not needing to be distinguished from each other.

FIG. 3 schematically illustrates an example in which the pixels 10A are disposed in a matrix of two rows and two columns. The number and disposition of pixels 10A in the image capturing device 120A are not limited to those in the example illustrated in FIG. 3 as long as the pixels 10A include at least one set of the pixel 10AA and the pixel 10AB. A plane on which the pixels 10A are two-dimensionally arrayed is referred to as an imaging plane in some cases.

Each pixel 10A includes a photoelectrical conversion unit 13 and a signal detection circuit 14. As described below with reference to drawings, the photoelectrical conversion unit 13 includes a photoelectric conversion layer sandwiched between two electrodes facing each other and generates a signal upon receiving incident light. The photoelectrical conversion unit 13 does not necessarily need to be an element that is entirely independent for the pixel 10A, and for example, part of the photoelectrical conversion unit 13 may be shared by a plurality of pixels 10A. The signal detection circuit 14 detects signal charge generated by the photoelectrical conversion unit 13. Specifically, the signal detection circuit 14 reads a signal corresponding to signal charge accumulated in a charge accumulation node 41 to be described later. In this example, the signal detection circuit 14 includes a signal detection transistor 24 and an address transistor 26. The signal detection transistor 24 and the address transistor 26 are, for example, field-effect transistors (FETs), and in this example, the signal detection transistor 24 and the address transistor 26 are n-channel metal oxide semiconductor field-effect transistors (MOSFETs). Transistors such as the signal detection transistor 24, the address transistor 26, and a reset transistor 28 to be described later each include a control terminal, an input terminal, and an output terminal. The control terminal is, for example, a gate. The input terminal is one of a drain and a source and is, for example, the drain. The output terminal is the other of the drain and the source and is, for example, the source.

As schematically illustrated in FIG. 3, the control terminal of the signal detection transistor 24 is electrically connected to the photoelectrical conversion unit 13. Signal charge generated by the photoelectrical conversion unit 13 is accumulated in the charge accumulation node 41 between the gate of the signal detection transistor 24 and the photoelectrical conversion unit 13. The signal charge is holes or electrons. The charge accumulation node 41 is an exemplary charge accumulation part and also referred to as a “floating diffusion node”. The structure of the photoelectrical conversion unit 13 will be described in detail later.

The image capturing device 120A includes a drive unit configured to drive the pixel array PA and acquire images at a plurality of timings. The drive unit includes a voltage supply circuit 32, a voltage supply circuit 33, a reset voltage source 34, a vertical scanning circuit 36, a column signal processing circuit 37, and a horizontal signal reading circuit 38.

In the example of the image capturing device 120A illustrated in FIG. 3, the photoelectrical conversion unit 13 of each pixel 10A is connected to any one of a sensitivity control line 42 and a sensitivity control line 43. Specifically, the photoelectrical conversion unit 13 of each pixel 10AA is connected to the sensitivity control line 42. The photoelectrical conversion unit 13 of each pixel 10AB is connected to the sensitivity control line 43. The pixels 10AA and 10AB have the same configuration except that, for example, their photoelectrical conversion units 13 are connected to different sensitivity control lines. Among the pixels 10A on the imaging plane, the pixels 10AA connected to the sensitivity control line 42 and the pixels 10AB connected to the sensitivity control line 43 are alternately arrayed in vertical and horizontal directions. In the configuration exemplarily illustrated in FIG. 3, the sensitivity control line 42 is connected to the voltage supply circuit 32, and the sensitivity control line 43 is connected to the voltage supply circuit 33. Although described later in detail, the voltage supply circuit 32 and the voltage supply circuit 33 supply voltages different from each other to the sensitivity control line 42 and the sensitivity control line 43, respectively.

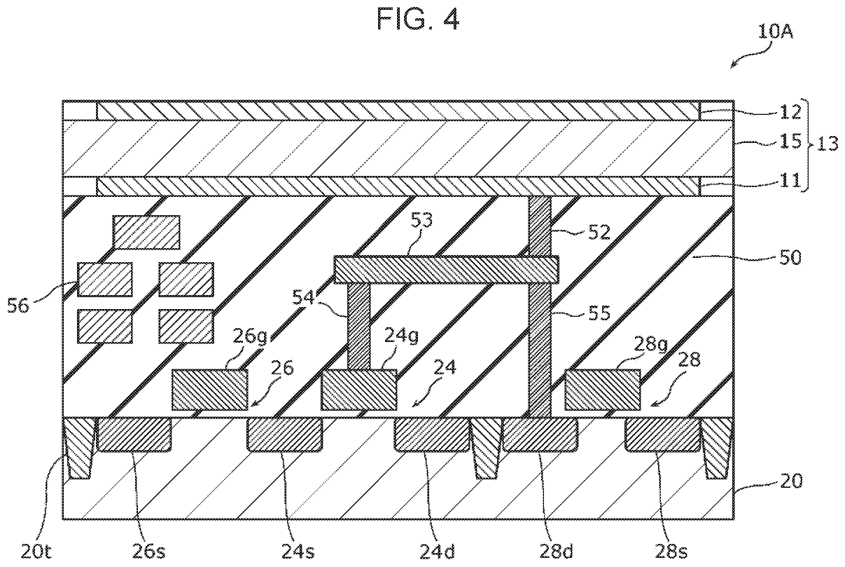

Each pixel 10A includes a pixel electrode 11 and a counter electrode 12. The configuration of the electrodes will be described in detail later with reference to FIG. 4. Any of holes or electrons of hole-electron pairs generated in a photoelectric conversion layer 15 to be described later through photoelectric conversion can be collected by the pixel electrode 11 by controlling the potential of the counter electrode 12 relative to the potential of the pixel electrode 11 with the voltage supply circuit 32 and the voltage supply circuit 33. For example, when holes are used as signal charge, the holes can be selectively collected by the pixel electrode 11 by controlling the potential of the counter electrode 12 to be higher than the potential of the pixel electrode 11. The amount of signal charge collected per unit time changes in accordance with the potential difference between the pixel electrode 11 and the counter electrode 12. The following description will be made on an example in which holes are used as signal charge. Electrons may be used as signal charge instead. The voltage supply circuit 32 and the voltage supply circuit 33 are each not limited to particular power circuits but may be each a circuit configured to generate predetermined voltage or a circuit configured to convert voltage supplied from another power source into predetermined voltage.

Each pixel 10A is connected to a power source line 40 that supplies power voltage VDD. As illustrated, the power source line 40 is connected to the input terminal of the signal detection transistor 24. The power source line 40 functions as a source-follower power source, and accordingly, the signal detection transistor 24 amplifies a signal generated by the photoelectrical conversion unit 13 and outputs the amplified signal.

The input terminal of the address transistor 26 is connected to the output terminal of the signal detection transistor 24. The output terminal of the address transistor 26 is connected to one of a plurality of vertical signal lines 47 disposed for the respective columns of the pixel array PA. The control terminal of the address transistor 26 is connected to an address control line 46, and output from the signal detection transistor 24 can be selectively read to the corresponding vertical signal lines 47 by controlling the potential of the address control line 46.

In the illustrated example, the address control line 46 is connected to the vertical scanning circuit 36. The vertical scanning circuit 36 is also referred to as a “row scanning circuit”. The vertical scanning circuit 36 selects pixels 10A disposed on each row by applying predetermined voltage to the address control line 46. Accordingly, signal reading from the selected pixels 10A and resetting of the pixel electrode 11, that is, the charge accumulation node 41 to be described later are executed.

In addition, a pixel drive signal generation circuit 39 is connected to the vertical scanning circuit 36. In the illustrated example, the pixel drive signal generation circuit 39 generates a signal that drives pixels 10A disposed on each row of the pixel array PA, and the pixel drive signal thus generated is supplied to pixels 10A on a row selected by the vertical scanning circuit 36.

The vertical signal lines 47 are main signal lines through which pixel signals from the pixel array PA are transmitted to any peripheral circuit. The column signal processing circuit 37 is connected to the vertical signal lines 47. The column signal processing circuit 37 is also referred to as a “row signal accumulation circuit”. The column signal processing circuit 37 performs, for example, noise suppression signal processing such as correlated double sampling, and analog-digital conversion (AD conversion). As illustrated, the column signal processing circuit 37 is provided for each column of pixels 10A in the pixel array PA. The horizontal signal reading circuit 38 is connected to the column signal processing circuits 37. The horizontal signal reading circuit 38 is also referred to as a “column scanning circuit”. The horizontal signal reading circuit 38 sequentially reads signals from the column signal processing circuits 37 to a horizontal common signal line 49.

In the configuration exemplarily illustrated in FIG. 3, the reset transistor 28 is included in each pixel 10A. The reset transistor 28 may be, for example, a field-effect transistor like the signal detection transistor 24 and the address transistor 26. Unless otherwise stated, the following description will be made on an example in which an n-channel MOSFET is employed as the reset transistor 28. As illustrated, the reset transistor 28 is connected between a reset voltage line 44 that supplies reset voltage Vr and the charge accumulation node 41. The control terminal of the reset transistor 28 is connected to a reset control line 48, and the potential of the charge accumulation node 41 can be reset to the reset voltage Vr by controlling the potential of the reset control line 48. In this example, the reset control line 48 is connected to the vertical scanning circuit 36. Thus, as the vertical scanning circuit 36 applies predetermined voltage to the reset control line 48, pixels 10A disposed on the corresponding row can be reset.

In this example, the reset voltage line 44 that supplies the reset voltage Vr to each reset transistor 28 is connected to the reset voltage source 34. The reset voltage source 34 is also referred to as a “reset voltage supply circuit”. The reset voltage source 34 only needs to have a configuration that can supply the predetermined reset voltage Vr to the reset voltage line 44 when the image capturing device 120A operates, and is not limited to a particular power circuit like the above-described voltage supply circuit 32. The voltage supply circuit 32 and the reset voltage source 34 may be each part of a single voltage supply circuit or may be independent different voltage supply circuits. One or both of the voltage supply circuit 32 and the reset voltage source 34 may be part of the vertical scanning circuit 36. Alternatively, sensitivity control voltage from the voltage supply circuit 32 and/or the reset voltage Vr from the reset voltage source 34 may be supplied to each pixel 10A through the vertical scanning circuit 36.

The power voltage VDD of the signal detection circuit 14 may be used as the reset voltage Vr. In this case, a voltage supply circuit configured to supply power voltage to each pixel 10A, which is not illustrated in FIG. 3, and the reset voltage source 34 can be integrated. In addition, the power source line 40 and the reset voltage line 44 can be integrated, and thus wiring in the pixel array PA can be simplified. However, the image capturing device 120A can be more flexibly controlled by setting the reset voltage Vr to voltage different from the power voltage VDD of the signal detection circuit 14.

### Pixel Device Structure

The device structure of each pixel 10A of the image capturing device 120A will be described below. FIG. 4 is a sectional view schematically illustrating an exemplary device structure of each pixel 10A according to the present embodiment. In the configuration exemplarily illustrated in FIG. 4, the signal detection transistor 24, the address transistor 26, and the reset transistor 28 described above are formed on a semiconductor substrate 20. The semiconductor substrate 20 is not limited to a substrate entirely made of a semiconductor. The semiconductor substrate 20 may be, for example, an insulating substrate provided with a semiconductor layer on a surface on a side on which a photosensitive region is formed. In this example, the semiconductor substrate 20 is a p-type silicon (Si) substrate.

The semiconductor substrate 20 includes impurity regions 26s, 24s, 24d, 28d, and 28s and an element separation region 20t for electric separation from pixels 10A. In this example, the impurity regions 26s, 24s, 24d, 28d, and 28s are n-type regions. Another element separation region 20t is provided between the impurity region 24d and the impurity region 28d. Each element separation region 20t is formed by performing, for example, acceptor ion implantation under a predetermined injection condition.

The impurity regions 26s, 24s, 24d, 28d, and 28s are, for example, impurity diffusion layers formed in the semiconductor substrate 20. As schematically illustrated in FIG. 4, the signal detection transistor 24 includes the impurity regions 24s and 24d and a gate electrode 24g. The gate electrode 24g is formed of a conductive material. The conductive material is, for example, polysilicon provided with conductivity by impurity doping but may be a metal material. The impurity region 24s functions as, for example, a source region of the signal detection transistor 24. The impurity region 24d functions as, for example, a drain region of the signal detection transistor 24. A channel region of the signal detection transistor 24 is formed between the impurity regions 24s and 24d.

Similarly, the address transistor 26 includes the impurity regions 26s and 24s and a gate electrode 26g connected to the address control line 46 (refer to FIG. 3). The gate electrode 26g is formed of a conductive material. The conductive material is, for example, polysilicon provided with conductivity by impurity doping but may be a metal material. In this example, the signal detection transistor 24 and the address transistor 26 are electrically connected to each other by sharing the impurity region 24s. The impurity region 24s functions as, for example, a drain region of the address transistor 26. The impurity region 26s functions as, for example, a source region of the address transistor 26. The impurity region 26s is connected to the corresponding vertical signal line 47 (refer to FIG. 3), which is not illustrated in FIG. 4. The impurity region 24s do not necessarily need to be shared by the signal detection transistor 24 and the address transistor 26. Specifically, the source region of the signal detection transistor 24 and the drain region of the address transistor 26 may be separated from each other in the semiconductor substrate 20 and electrically connected to each other through a wiring layer provided in an interlayer insulating layer 50.

The reset transistor 28 includes the impurity regions 28d and 28s and a gate electrode 28g connected to the corresponding reset control line 48 (refer to FIG. 3). The gate electrode 28g is formed of, for example, a conductive material. The conductive material is, for example, polysilicon provided with conductivity by impurity doping but may be a metal material. The impurity region 28s functions as, for example, a source region of the reset transistor 28. The impurity region 28s is connected to the reset voltage line 44 (refer to FIG. 3), which is not illustrated in FIG. 4. The impurity region 28d functions as, for example, a drain region of the reset transistor 28.

The interlayer insulating layer 50 is disposed over the signal detection transistor 24, the address transistor 26, and the reset transistor 28 on the semiconductor substrate 20. The interlayer insulating layer 50 is formed of an insulating material such as silicon dioxide. As illustrated, a wiring layer 56 may be disposed in the interlayer insulating layer 50. The wiring layer 56 is formed of a metal such as copper and may include a signal line such as the vertical signal line 47 or the power source line. The number of insulating layers in the interlayer insulating layer 50 and the number of layers included in the wiring layer 56 disposed in the interlayer insulating layer 50 may be optionally set and are not limited to those in the example illustrated in FIG. 4.

The above-described photoelectrical conversion unit 13 is disposed on the interlayer insulating layer 50. In other words, in the present embodiment, the pixels 10A constituting the pixel array PA (refer to FIG. 3) are formed in the semiconductor substrate 20 and on the semiconductor substrate 20. The pixels 10A two-dimensionally arrayed on the semiconductor substrate 20 form a photosensitive region. The photosensitive region is also referred to as a pixel region. The distance between two adjacent pixels 10A, in other words, the pixel pitch may be, for example, 2 μm approximately.

The photoelectrical conversion unit 13 includes the pixel electrode 11, the counter electrode 12, and the photoelectric conversion layer 15 disposed therebetween. In the illustrated example, the photoelectric conversion layer 15 is formed across the pixels 10A. The pixel electrode 11 is provided for each pixel 10A and electrically separated from the pixel electrode 11 of another adjacent pixel 10A through spatial separation from the pixel electrode 11 of the other pixel 10A. At least the counter electrodes 12 of the pixels 10AA and 10AB adjacent to each other among the pixels 10A are spatially separated. Accordingly, the counter electrodes 12 of the pixels 10AA and 10AB adjacent to each other are electrically separated. Each counter electrode 12 may be formed across a plurality of pixels 10AA. Each counter electrode 12 may be formed across a plurality of pixels 10AB.

The counter electrode 12 is, for example, a transparent electrode formed of a transparent conductive material. The counter electrode 12 is disposed on a side of the photoelectric conversion layer 15 on which light is incident. Accordingly, light having transmitted through the counter electrode 12 is incident on the photoelectric conversion layer 15. Light detected by the image capturing device 120A is not limited to light in the wavelength range of visible light. The image capturing device 120A may detect, for example, infrared light or ultraviolet light. The wavelength range of visible light is, for example, more than or equal to 380 nm and less than or equal to 780 nm. In the present specification, “transparent” means transmission of at least part of light in a wavelength range to be detected, and transmission of light in the entire wavelength range of visible light is not essential. In the present specification, general electromagnetic waves including infrared light and ultraviolet light are expressed as “light” for sake of simplicity. The counter electrode 12 may be formed of transparent conductive oxide (TCO) such as ITO, IZO, AZO, FTO, SnO₂, TiO₂, or ZnO₂.

The photoelectric conversion layer 15 receives incident light and generates hole-electron pairs. The photoelectric conversion layer 15 is formed of, for example, an organic semiconductor material. The photoelectric conversion layer 15 may be formed of an inorganic semiconductor material.

As described above with reference to FIG. 3, the counter electrode 12 is connected to the sensitivity control line 42 connected to the voltage supply circuit 32 or is connected to the sensitivity control line 43 connected to the voltage supply circuit 33. For example, the counter electrode 12 is formed across a plurality of pixels 10AA. For example, the counter electrode 12 is formed across a plurality of pixels 10AB. Thus, sensitivity control voltage of desired magnitude can be applied between each of a plurality of pairs of pixels 10AA and 10AB all at once from the voltage supply circuit 32 and the voltage supply circuit 33 through the sensitivity control line 42 and the sensitivity control line 43. The counter electrode 12 may be separately provided for each pixel 10A as long as sensitivity control voltage of desired magnitude can be applied from the voltage supply circuit 32 and the voltage supply circuit 33. Similarly, the photoelectric conversion layer 15 may be separately provided for each pixel 10A.

Any of holes or electrons of hole-electron pairs generated in the photoelectric conversion layer 15 through photoelectric conversion can be collected by the pixel electrode 11 by controlling the potential of the counter electrode 12 relative to the potential of the pixel electrode 11. For example, when holes are used as signal charge, the holes as signal charge can be selectively collected by the pixel electrode 11 by controlling the potential of the counter electrode 12 to be higher than the pixel electrode 11. The amount of signal charge collected per unit time changes in accordance with the potential difference between the pixel electrode 11 and the counter electrode 12. The following description will be made on an example in which holes are used as signal charge. Electrons may be used as signal charge.

The pixel electrode 11 is formed of, for example, metal such as aluminum or copper, metal nitride, or polysilicon provided with conductivity by impurity doping.

The pixel electrode 11 may be a light-shielding electrode. For example, when the pixel electrode 11 is formed as a TaN electrode having a thickness of 100 nm, a sufficient light-shielding property can be obtained. When the pixel electrode 11 is a light-shielding electrode, light having passed through the photoelectric conversion layer 15 can be prevented from being incident on the channel or impurity region of a transistor formed in the semiconductor substrate 20. In the illustrated example, the transistor is at least one of the signal detection transistor 24, the address transistor 26, or the reset transistor 28. A light-shielding film may be formed in the interlayer insulating layer 50 by using the above-described wiring layer 56. When light is prevented from being incident on the channel region of a transistor formed in the semiconductor substrate 20 by such a light-shielding electrode or a light-shielding film, for example, characteristic shift of the transistor such as variation of the threshold voltage of the transistor can be prevented. Moreover, when light is prevented from being incident on an impurity region formed in the semiconductor substrate 20, mixture of noise due to unintended photoelectric conversion in the impurity region can be prevented. In this manner, prevention of light incidence on the semiconductor substrate 20 contributes to improvement of the reliability of the image capturing device 120A.

As schematically illustrated in FIG. 4, the pixel electrode 11 is connected to the gate electrode 24g of the signal detection transistor 24 through a plug 52, a wire 53, and a contact plug 54. In other words, the gate of the signal detection transistor 24 is electrically connected to the pixel electrode 11. The plug 52 and the wire 53 may be formed of a metal such as copper. The plug 52, the wire 53, and the contact plug 54 constitute at least part of the charge accumulation node 41 (refer to FIG. 3) between the signal detection transistor 24 and the photoelectrical conversion unit 13. The wire 53 may be part of the wiring layer 56. The pixel electrode 11 is also connected to the impurity region 28d through the plug 52, the wire 53, and a contact plug 55. In the configuration exemplarily illustrated in FIG. 4, the gate electrode 24g of the signal detection transistor 24, the plug 52, the wire 53, the contact plugs 54 and 55, and the impurity region 28d as one of the source and drain regions of the reset transistor 28 function as a charge accumulation region such as the charge accumulation node 41 in which signal charge collected by the pixel electrode 11 is accumulated.

As signal charge is collected by the pixel electrode 11, voltage in accordance with the amount of signal charge accumulated in the charge accumulation region is applied to the gate of the signal detection transistor 24. The signal detection transistor 24 amplifies the voltage. The voltage amplified by the signal detection transistor 24 is selectively read as signal voltage through the address transistor 26.

The image capturing device 120A as described above may be manufactured through a typical semiconductor manufacturing process. When a silicon substrate is used as the semiconductor substrate 20, in particular, the image capturing device 120A may be manufactured by exploiting various kinds of silicon semiconductor processes.

### Operation of Distance Measurement Device

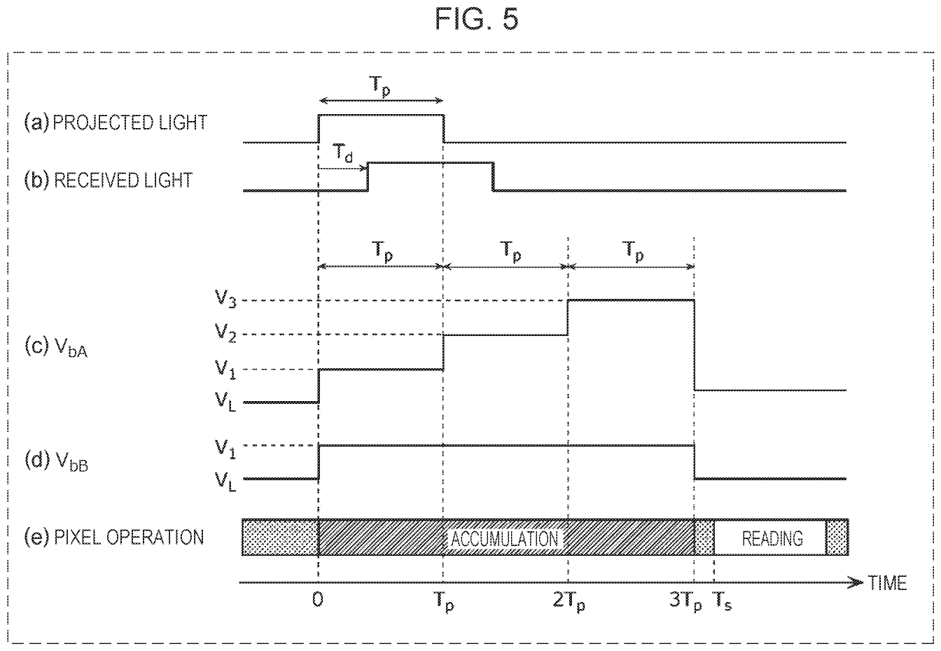

Operation of the distance measurement device 100 according to the present embodiment will be described below. Distance image acquisition by the image capturing device 120A will be described first with reference to FIG. 5. FIG. 5 is a timing chart illustrating exemplary operation of the distance measurement device 100 according to the present embodiment. Graph (a) in FIG. 5 illustrates the waveform of pulse light projected from the light source 140 of the distance measurement device 100 onto the object. In the following description, the pulse light thus projected is referred to as “projected light” or “projected pulse light”. As illustrated in FIG. 5, the object is irradiated with the projected light for the period of the pulse width Tₚ from a certain time point, which is time point 0 in FIG. 5. The period of the pulse width Tₚ from time point 0 is an exemplary first period. The length of the pulse width Tₚ is the length of the first period, and the light source 140 projects first pulse light in the first period through irradiation with light such as infrared light for the first period. Graph (b) in FIG. 5 illustrates the waveform of pulse light incident on the image capturing device 120A after the projected light from the light source 140, which is illustrated by Graph (a) in FIG. 5, is reflected by the object positioned at the distance d from the distance measurement device 100. In the following description, pulse light reflected by the object and incident on the image capturing device 120A is referred to as “reflected light”. As illustrated in (b) in FIG. 5, the reflected light in this example is incident on the image capturing device 120A at a delay time that is the flight time T_{d} of the projected light behind the projected light. The distance to the object can be calculated by using Expression (2) above by calculating the flight time T_{d}.

As described above with reference to FIG. 3, the image capturing device 120A in the present embodiment includes the two voltage supply circuits 32 and 33 and the two sensitivity control lines 42 and 43 connected thereto, respectively, and voltages different from each other are applied to the counter electrode 12 of each pixel 10AA connected to the sensitivity control line 42 and the counter electrode 12 of the pixel 10AB connected to the sensitivity control line 43. The magnitudes of the voltages supplied from the voltage supply circuits 32 and 33 and the timings of changing the magnitudes of the voltages are controlled by, for example, the control unit 130. Graph (c) in FIG. 5 illustrates temporal change of voltage V_{bA} supplied from the voltage supply circuit 32 to the counter electrode 12 of each pixel 10AA connected through the sensitivity control line 42. Graph (d) in FIG. 5 illustrates temporal change of voltage V_{bB} supplied from the voltage supply circuit 33 to the counter electrode 12 of each pixel 10AB connected through the sensitivity control line 43.

The voltage V_{bA} indicated by Graph (c) in FIG. 5 is supplied from the voltage supply circuit 32 to the counter electrode 12 of each pixel 10AA, and the voltage V_{bB} indicated by Graph (d) in FIG. 5 is supplied from the voltage supply circuit 33 to the counter electrode 12 of each pixel 10AB. In the following description, each pixel 10AA supplied with the voltage V_{bA} illustrated in (c) in FIG. 5 is referred to as a variable sensitivity pixel, and each pixel 10AB supplied with the voltage V_{bB} illustrated in (d) in FIG. 5 is referred to as a fixed sensitivity pixel in some cases.

As illustrated in (c) in FIG. 5, the value of the voltage V_{bA} applied to the counter electrode 12 of each variable sensitivity pixel is changed as time elapses. More specifically, as illustrated in FIG. 5, when time point 0 is a time point at which the projected light is turned on, the voltage V_{bA} is set to predetermined voltage V_{L} before time point 0, to voltage V₁ higher than the voltage V_{L} in the period from time point 0 to time point Tₚ, to voltage V₂ higher than the voltage V₁ in the period from time point Tₚ to time point 2Tₚ, and to voltage V₃ higher than the voltage V₂ in the period from time point 2Tₚ to time point 3Tₚ. Thereafter, the voltage V_{bA} is set to the voltage V_{L} in the period later than time point 3Tₚ. The period from time point 0 to time point Tₚ is an exemplary second period, the period from time point Tₚ to time point 2Tₚ, following the second period, is an exemplary third period, and the period from time point 2Tₚ to time point 3Tₚ, following the third period, is an exemplary fourth period. The lengths of the second, third, and fourth periods are equal to, for example, the length of the first period. The length of the fourth period may be different from the length of the first period. To avoid narrowing of the range of distance measurement, the length of the fourth period is, for example, equal to or longer than the length of the first period.

The voltage V_{bB} applied to the counter electrode 12 of each fixed sensitivity pixel is fixed to the voltage V₁ in the period from time point 0 to time point 3Tₚ, which is a first light-reception period. Specifically, the voltage V_{bA} and the voltage V_{bB} are expressed by Expressions (4) and (5) below as functions of time t.

$${V}_{bA} = \{ \begin{matrix}{V}_{L} , & t < 0 , t \geq 3 {T}_{p} \\ {V}_{1} , & 0 \leq t < {T}_{p} \\ {V}_{2} , & {T}_{p} \leq t < 2 {T}_{p} \\ {V}_{3} , & 2 {T}_{p} \leq t < 3 {T}_{p}\end{matrix} \qquad ( 4 )$$

$${V}_{bB} = \{ \begin{matrix}{V}_{L} , & t < 0 , t \geq 3 {T}_{p} \\ {V}_{1} , & 0 \leq t < 3 {T}_{p}\end{matrix} \qquad ( 5 )$$

Graph (e) in FIG. 5 schematically illustrates the timings of electric charge accumulation and reading operation at each pixel 10A of the image capturing device 120A. As illustrated in (e) in FIG. 5, at each pixel 10A, reading is not performed but accumulation of signal charge generated through photoelectric conversion is performed in a period in which any of the voltages V₁ to V₃ is applied to the counter electrode 12 of each variable sensitivity pixel and the voltage V₁ is applied to the counter electrode 12 of each fixed sensitivity pixel, in other words, the period illustrated with a hatched rectangle in (e) in FIG. 5. Reading of signal charge from each pixel 10A starts at time point Tₛ after the application of a series of variable voltages or fixed voltage to the counter electrode 12 of each variable sensitivity pixel or fixed sensitivity pixel is completed and the voltages V_{bA} and V_{bB} applied to the counter electrodes 12 are changed to the predetermined voltage V_{L}. The period in which reading is performed is illustrated with a white rectangle in (e) in FIG. 5. The start time Tₛ of signal charge reading from each pixel 10A may coincide with time point 3Tₚ in FIG. 5, in other words, a time point at which the voltage V_{bA} or V_{bB} applied to the counter electrode 12 of each pixel 10A is changed to V_{L} or may be set to a time point after a predetermined time has elapsed since time point 3Tₚ. In the following description of the operation of the distance measurement device 100 in the present disclosure, description of the timing of reading operation at a pixel such as a pixel 10A is omitted in some cases. In such a case as well, similarly to (e) in FIG. 5, reading operation at a pixel such as a pixel 10A is started after predetermined variable voltage or fixed voltage is applied to the counter electrode 12 of each pixel and then the voltage V_{L} is applied to the counter electrode 12.

In the following description, the above-described period illustrated with a hatched rectangle in (e) in FIG. 5, in which the voltage V_{bA} applied to the counter electrode 12 of each variable sensitivity pixel is set to any of the voltages V₁ to V₃, in other words, voltage other than the voltage V_{L}, is referred to as a charge accumulation period in some cases. The charge accumulation period is an exemplary first light-reception period. In the example illustrated in FIG. 5, the first light-reception period is constituted by the first, second, and third periods from time point 0 to time point 3Tₚ. The period illustrated with a white rectangle in (e) in FIG. 5 after the charge accumulation period, in which the voltage V_{bA} applied to the counter electrode 12 is set to the voltage V_{L} and then reading from each pixel 10A is performed, is referred to as a pixel reading period in some cases. The periods illustrated with dotted rectangles in (e) in FIG. 5, which correspond to none of the charge accumulation period and the pixel reading period, namely the period from the end time point of the charge accumulation period to the start time of the pixel reading period and the period from the end time point of the pixel reading period to the start time of the next charge accumulation period, are referred to as blanking periods in some cases. In addition, a period constituted by the pixel reading period and the blanking periods, in other words, at least a period following the charge accumulation period is referred to as a non-light-reception period in some cases. The non-light-reception periods may be continuously provided before and after the charge accumulation period.

In the example illustrated in FIG. 3, the image capturing device 120A according to the present embodiment includes the plurality of two-dimensionally arrayed pixels 10A. The operation timing chart illustrated in FIG. 5 corresponds to one set of a pixel 10AA and a pixel 10AB. In a timing example described below, the operation timing chart is applied to a case of a plurality of pixels 10A.

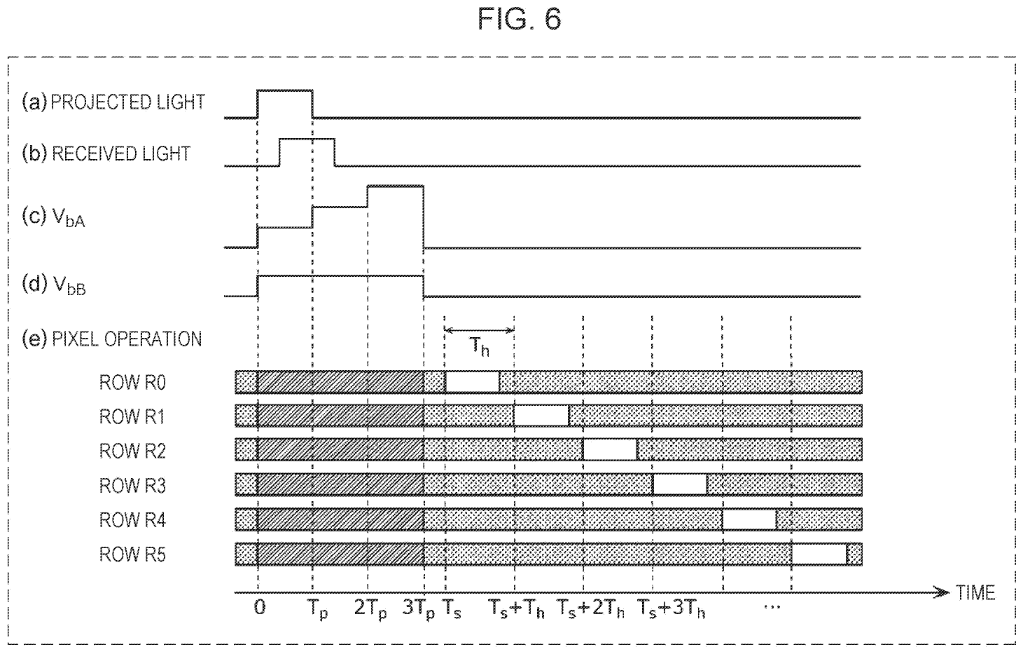

FIG. 6 is a timing chart illustrating exemplary operation of a plurality of pixels 10A. Graphs (a) to (d) in FIG. 6 are identical to Graphs (a) to (d) in FIG. 5. Specifically, the values of the voltages V_{bA} and V_{bB} in (c) and (d) in FIG. 6 are omitted but identical to those in (c) and (d) in FIG. 5. Graph (e) in FIG. 6 illustrates a schematic diagram of operation timings of a plurality of pixels 10A on the imaging plane, specifically, pixels 10A belonging to the rows R0 to row R5 on the imaging plane. In (e) in FIG. 6, each hatched rectangle represents the charge accumulation period on a row, each white rectangle represents the pixel reading period on a row, and each dotted rectangle represents a blanking period on a row.

As illustrated in FIG. 6, first at time point 0, the light source 140 projects pulse light onto the object. Simultaneously, the voltage supply circuits 32 and 33 change, to the voltages V_{L} to V₁, the voltage V_{bA} applied to the counter electrode 12 of each variable sensitivity pixel and the voltage V_{bB} applied to the counter electrode 12 of each fixed sensitivity pixel, respectively. Thereafter, as described above with reference to FIG. 5, the voltage supply circuit 32 sequentially increases the voltage V_{bA} applied to the counter electrode 12 of each variable sensitivity pixel to the voltages V₂ and V₃ at each elapse of a time equal to the pulse width Tₚ of the projected pulse light. The voltage supply circuit 33 maintains, at the voltage V₁, the voltage V_{bB} applied to the counter electrode 12 of each fixed sensitivity pixel. Thereafter, at time point 3Tₚ, the voltage supply circuits 32 and 33 change, to the voltage V_{L} again, the voltage V_{bA} applied to the counter electrode 12 of each variable sensitivity pixel and the voltage V_{bB} applied to the counter electrode 12 of each fixed sensitivity pixel, respectively. In the image capturing device 120A according to the present embodiment, this voltage change is simultaneously performed on all variable sensitivity pixels and all fixed sensitivity pixels on the imaging plane.

At time point Tₛ later than time point 3Tₚ when the voltage V_{bA} applied to each variable sensitivity pixel and the voltage V_{bB} applied to each fixed sensitivity pixel are set to the voltage V_{L}, the row R0 is selected by the vertical scanning circuit 36 and reading operation at pixels 10A belonging to the row R0 is simultaneously performed for each column in parallel. In the image capturing device 120A according to the present embodiment, variable sensitivity pixels and fixed sensitivity pixels are both disposed on each pixel row, and reading is simultaneously performed at these pixels. Thereafter, the pixel row that is selected by the vertical scanning circuit 36 and from which signal reading is performed is sequentially updated to the row R1, the row R2, . . . , at each elapse of time Tₕ illustrated in (e) in FIG. 6, for example. As illustrated in (e) in FIG. 6, the interval time Tₕ of update of the selected row is set to the time of signal reading from each pixel 10A, in other words, a length equal to or longer than the width of a white rectangle in (e) in FIG. 6. Accordingly, in this example, the start and end time points of the charge accumulation period are the same among all pixels 10A on the imaging plane, but the start and end time points of the pixel reading period are different among the pixel rows, as illustrated in (e) in FIG. 6. The start and end time points of the pixel reading period may be the same among pixels 10A disposed on pixel rows different from each other in a case of a configuration in which signal reading from each pixel 10A can be independently performed unlike the example in (e) in FIG. 6, for example, in a case of a configuration in which a circuit having functions equivalent to those of each column signal processing circuit 37 in FIG. 3 is disposed for each pixel 10A.

In reading operation at each pixel 10A, for example, resetting of the charge accumulation node 41 of the pixel 10A and reading of any pixel signal accumulated after resetting are executed. In the distance measurement device 100 in the present embodiment, pixel signal reading and resetting of the charge accumulation node 41 for electric charge accumulation due to the next pulse light projection are performed in one pixel reading period.

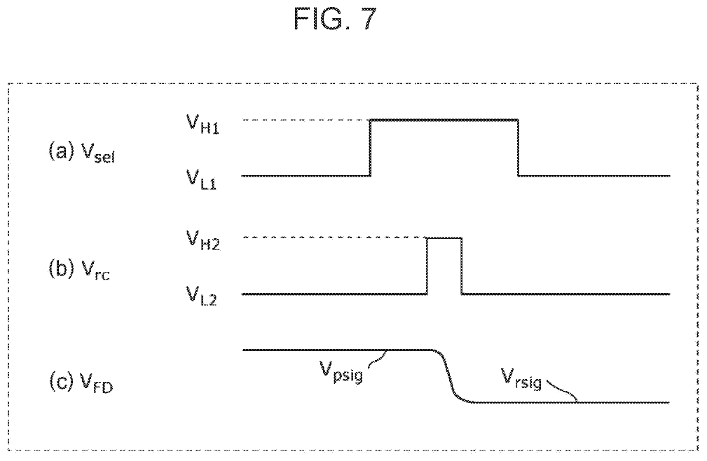

Time point Tₛ is an exemplary start time of the pixel reading period. FIG. 7 is a timing chart illustrating exemplary timings of control signals in the pixel reading period. “Vₛₑₗ” in (a) in FIG. 7 represents the potential of each address control line 46. The potential Vₛₑₗ changes to potential V_{L1} that is “Low” level and potential V_{H1} that is “High” level. “V_{rc}” in (b) in FIG. 7 represents the potential of each reset control line 48. The potential V_{rc} changes to potential V_{L2} that is “Low” level and potential V_{H2} that is “High” level. “V_{FD}” in (c) in FIG. 7 represents the potential of each charge accumulation node 41. The potential V_{FD} is used as a pixel signal V_{psig} when electric charge is accumulated in the charge accumulation node 41. The potential V_{FD} is used as a reset signal V_{rsig} when the charge accumulation node 41 is reset.

At time point Tₛ illustrated in FIG. 6, the potential Vₛₑₗ of the address control line 46 of the row R0 switches from the potential V_{L1} as “Low” level to the potential V_{H1} as “High” level as illustrated in (a) in FIG. 7. Accordingly, each address transistor 26 having a gate connected to the address control line 46 switches from “OFF” to “ON” and the potential V_{FD} of the charge accumulation node 41 is output to the corresponding vertical signal line 47. Specifically, the pixel signal V_{psig} is output to the vertical signal line 47. The pixel signal V_{psig} corresponds to the amount of electric charge accumulated in the charge accumulation node 41 due to photoelectric conversion of reflected light from the object upon the previous pulse light projection. The pixel signal V_{psig} is transmitted to the corresponding column signal processing circuit 37.

In the examples illustrated in FIGS. 5 and 6, the signal reading period illustrated with a white rectangle in Graph (e) includes a period for reading the pixel signal V_{psig} and a reset period. The reset period is a period for resetting the potential of the charge accumulation node 41 of each pixel 10A. Specifically, in this example, resetting of the pixels 10A belonging to the row R0 is performed after completion of the above-described pixel reading. For example, AD conversion of a pixel signal at each column signal processing circuit 37 may be interposed between the pixel reading completion and the resetting of the pixels 10A belonging to the row R0.

The resetting of the pixels 10A belonging to the row R0 is performed through a procedure described below. The potential V_{rc} of the reset control line 48 of the row R0 switches from the potential V_{L2} as “Low” level to the potential V_{H2} as “High” level as illustrated in (b) in FIG. 7. Accordingly, each reset transistor 28 having a gate connected to the reset control line 48 switches from “OFF” to “ON”. Thus, the charge accumulation node 41 thereof is connected to the reset voltage line 44 and supplied with the reset voltage Vr. As a result, the potential of the charge accumulation node 41 is reset to the reset voltage Vr. The reset voltage Vr is, for example, 0 V.

Thereafter, the potential V_{rc} of the reset control line 48 switches from the potential V_{H2} as “High” level to the potential V_{L2} as “Low” level. Accordingly, each corresponding reset transistor 28 switches from “ON” to “OFF”. When the reset transistor 28 is “OFF”, the reset signal V_{rsig} is read from the corresponding pixel 10A on the row R0 through the corresponding vertical signal line 47. The reset signal V_{rsig} corresponds to the magnitude of the reset voltage Vr. The reset signal V_{rsig} is transmitted to the corresponding column signal processing circuit 37.

After the reading of the reset signal V_{rsig}, the potential Vₛₑₗ of the address control line 46 switches from the potential V_{H1} as “High” level to the potential V_{L1} as “Low” level. Accordingly, each corresponding address transistor 26 switches from “ON” to “OFF”.

As described above, the read pixel signal V_{psig} and the read reset signal V_{rsig} are transmitted to the corresponding column signal processing circuit 37. Fixed pattern noise can be removed by calculating the difference between these signals. Specifically, the noise is removed by subtracting the reset signal V_{rsig}, which corresponds to a noise component, from the pixel signal V_{psig}.

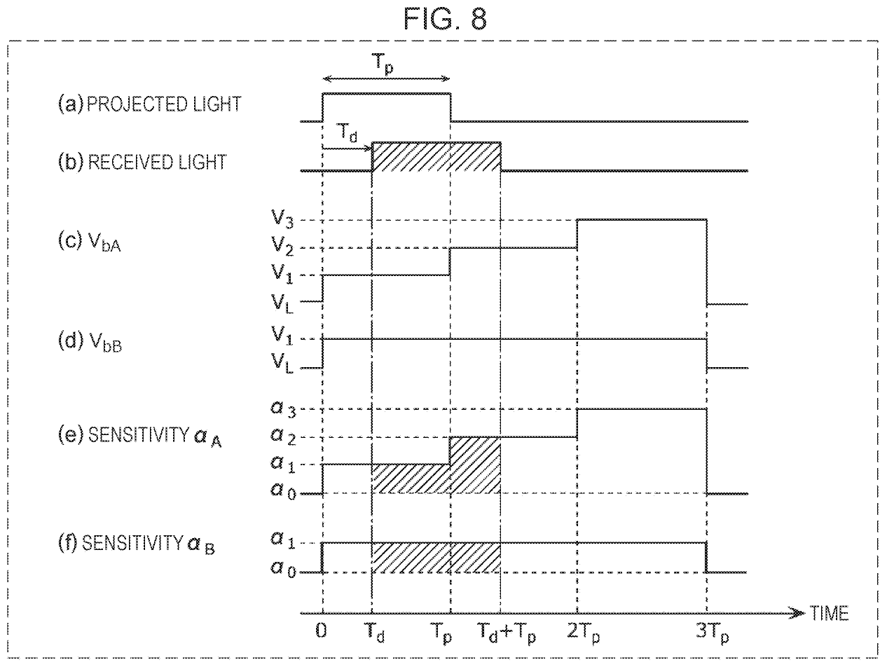

The principle of measurement of the distance to the object by the distance measurement device 100 according to the present embodiment will be described below with reference to FIG. 8. As described above for Expression (2) above, the distance d from the distance measurement device 100 to the object can be calculated when the flight time T_{d} can be measured, and thus the following description will be mainly made on the principle of measurement of the flight time T_{d}. FIG. 8 is a diagram for description of the principle of measurement of the distance to the object by the distance measurement device 100. Graphs (a) to (d) in FIG. 8 are identical to Graphs (a) to (d) in FIG. 5. Graphs (e) and (f) in FIG. 8 illustrate temporal changes of light receiving sensitivities obtained at each variable sensitivity pixel and each fixed sensitivity pixel by applying the voltages V_{bA} and V_{bB} illustrated in Graphs (c) and (d) in FIG. 8 to the counter electrode 12. In (e) and (f) in FIG. 8, the light receiving sensitivity of the image capturing device 120A changes in accordance with changes of the voltages V_{bA} and V_{bB} applied to the counter electrode 12. Thus, the sensitivity of the photoelectrical conversion unit 13 changes with the magnitude of applied voltage. The magnitudes of light receiving sensitivities corresponding to the voltages V₁, V₂, and V₃ applied to the counter electrode 12 are referred to as sensitivity α₁, sensitivity α₂, and sensitivity α₃.

In this manner, for example, the control unit 130 sets the sensitivity of each variable sensitivity pixel to the constant sensitivity α₁ in the period from time point 0 to time point Tₚ, to the constant sensitivity α₂ in the period from time point Tₚ to time point 2Tₚ, and to the constant sensitivity α₃ in the period from time point 2Tₚ to time point 3Tₚ. In other words, the control unit 130 adjusts the magnitude of voltage applied to the photoelectrical conversion unit 13 of each variable sensitivity pixel, thereby setting the sensitivity of the variable sensitivity pixel in the first period to the sensitivity α₁, setting the sensitivity thereof in the second period to the sensitivity α₂, and setting the sensitivity thereof in the third period to the sensitivity α₃. The sensitivities α₁, α₂, and α₃ are different from one another. The sensitivity α₂ is between the sensitivities α₁ and α₃. Accordingly, the image capturing device 120A detects reflected light from the object at the constant sensitivity α₁ in the period from time point 0 to time point Tₚ, at the constant sensitivity α₂ in the period from time point Tₚ to time point 2Tₚ, and at the constant sensitivity α₃ in the period from time point 2Tₚ to time point 3Tₚ. For example, the sensitivities α₁, α₂, and α₃ only need to be higher in the stated order and do not necessarily need to be higher at a constant ratio or with a constant difference in the stated order. In this manner, the light receiving sensitivity of each photoelectrical conversion unit 13 is set only by adjusting the magnitude of voltage applied to the photoelectrical conversion unit 13, and thus sensitivity setting operation can be simplified.

For example, the control unit 130 sets the sensitivity of each fixed sensitivity pixel to the constant sensitivity α₁ in the period from time point 0 to time point 3Tₚ. Accordingly, the image capturing device 120A detects reflected light from the object at the constant sensitivity α₁ in the period from time point 0 to time point 3Tₚ. The sensitivity set to each fixed sensitivity pixel in the charge accumulation period is not limited to the sensitivity α₁ but may be any sensitivity with which electric charge can be accumulated upon light reception of reflected light, that is, sensitivity that is not zero. The sensitivity set to each fixed sensitivity pixel in the charge accumulation period is, for example, any sensitivity set to each variable sensitivity pixel in the charge accumulation period, namely, any of the sensitivities α₁, α₂, and α₃ in the example illustrated in FIG. 8. Accordingly, calculation of the flight time T_{d} to be described later is simplified.

The magnitude of light receiving sensitivity corresponding to the voltage V_{L} applied to each counter electrode 12 is referred to as sensitivity α₀. Thus, the control unit 130 sets the sensitivity of each variable sensitivity pixel and the sensitivity of each fixed sensitivity pixel to the sensitivity α₀. The sensitivity α₀ is lower than the sensitivity of each variable sensitivity pixel in the charge accumulation period, in other words, is lower than any of the sensitivities α₁, α₂, and α₃. The sensitivity α₀ is, for example, substantially zero. In other words, the voltage V_{L} is voltage with which the light receiving sensitivity of the image capturing device 120A becomes sufficiently low enough to be regarded as zero when the voltage is applied to the counter electrode 12. The light receiving sensitivity of each variable sensitivity pixel and the light receiving sensitivity of each fixed sensitivity pixel, which are represented by sensitivities α_{A} and α_{B}, respectively, are expressed by Expressions (6) and (7) below as functions of time t.

$${α}_{A} = \{ \begin{matrix}{α}_{0} , & t < 0 , t \geq 3 {T}_{p} \\ {α}_{1} , & 0 \leq t < {T}_{p} \\ {α}_{2} , & {T}_{p} \leq t < 2 {T}_{p} \\ {α}_{3} , & 2 {T}_{p} \leq t < 3 {T}_{p}\end{matrix} \qquad ( 6 )$$

$${α}_{B} = \{ \begin{matrix}{α}_{0} , & t < 0 , t \geq 3 {T}_{p} \\ {α}_{1} , & 0 \leq t < 3 {T}_{p}\end{matrix} \qquad ( 7 )$$

In the present embodiment, as the sensitivity α_{A}, the sensitivity α₁ is an exemplary first sensitivity, the sensitivity α₂ is an exemplary second sensitivity, and the sensitivity α₃ is an exemplary third sensitivity. As the sensitivity α_{B}, the sensitivity α₁ is an exemplary reference sensitivity for distance measurement used in distance calculation to be described later or the like. The sensitivity α₀ is an exemplary basis sensitivity.

As described above, the sensitivity α₀ can be substantially regarded as zero in a period in which the voltage V_{bA} applied to the counter electrode 12 of each variable sensitivity pixel and the voltage V_{bB} applied to the counter electrode 12 of each fixed sensitivity pixel are equal to the voltage V_{L}. In FIG. 6 described above, the start and end time points of the charge accumulation period are the same among the pixels 10A on all pixel rows. The start and end time points of the pixel reading period are different among the pixel rows, but the amount of signal charge accumulated in any pixel 10A substantially does not change from that in the charge accumulation period since light receiving sensitivity in the other period than the charge accumulation period is substantially zero. Thus, change of the amount of signal charge due to the time difference of the pixel reading period among the pixel rows is unlikely to occur in the image capturing device 120A according to the present embodiment.

The distance measurement device 100 according to the present embodiment captures an image of reflected light from the object at the image capturing device 120A including the pixels 10A to which the light receiving sensitivities expressed by Expressions (6) and (7) above are set. In each variable sensitivity pixel and each fixed sensitivity pixel on which reflected light illustrated in (b) in FIG. 8 is incident, the amount of electric charge generated through photoelectric conversion and accumulated corresponds to the area of a hatched part illustrated in (e) and (f) in FIG. 8. The amounts of electric charge accumulated in a variable sensitivity pixel and a fixed sensitivity pixel adjacent to each other due to reflected light illustrated in (b) in FIG. 8, which are represented by an electric charge amount S_{A} and an electric charge amount S_{B}, respectively, are expressed by Expressions (8) and (9) below. Signals having magnitudes in accordance with the electric charge amounts S_{A} and S_{B} are output from the respective pixels.

S_{A}=∫_{T}_{_{d}}^{T}^{_{d}}^{+T}^{ₚ}α_{A}Iₚₕdt (8)

S_{B}=∫_{T}_{_{d}}^{T}^{_{d}}^{+T}^{ₚ}α_{B}Iₚₕdt (9)

In the expressions, Iₚₕ represents photocurrent generated through photoelectric conversion of reflected light at each pixel. Any variable sensitivity pixel is disposed in proximity to at least one fixed sensitivity pixel, and the amounts of photocurrent generated by the same reflected pulse light at the variable sensitivity pixel and the fixed sensitivity pixel can be regarded as being equal.

In the example illustrated in FIG. 8, the delay time of reflected light relative to projected light, in other words, the flight time T_{d} of projected pulse light is 0≤T_{d}<Tₚ. The electric charge amounts S_{A} and S_{B} accumulated in the variable sensitivity pixel and the fixed sensitivity pixel are calculated by Expressions (10) and (11) below.

S_{A}=Iₚₕ{α₂−α₁)T_{d}+α₁Tₚ} (10)

S_{B}=Iₚₕα₁Tₚ (11)

The flight time T_{d} of projected pulse light is calculated by Expression (12) below based on Expressions (10) and (11).

$${T}_{d} = \frac{( {S}_{A} / {S}_{B} ) - 1}{{k}_{2} - 1} {T}_{p} \qquad ( 12 )$$

In the expression, k₂ is α₂/α₁ with k₂>1.

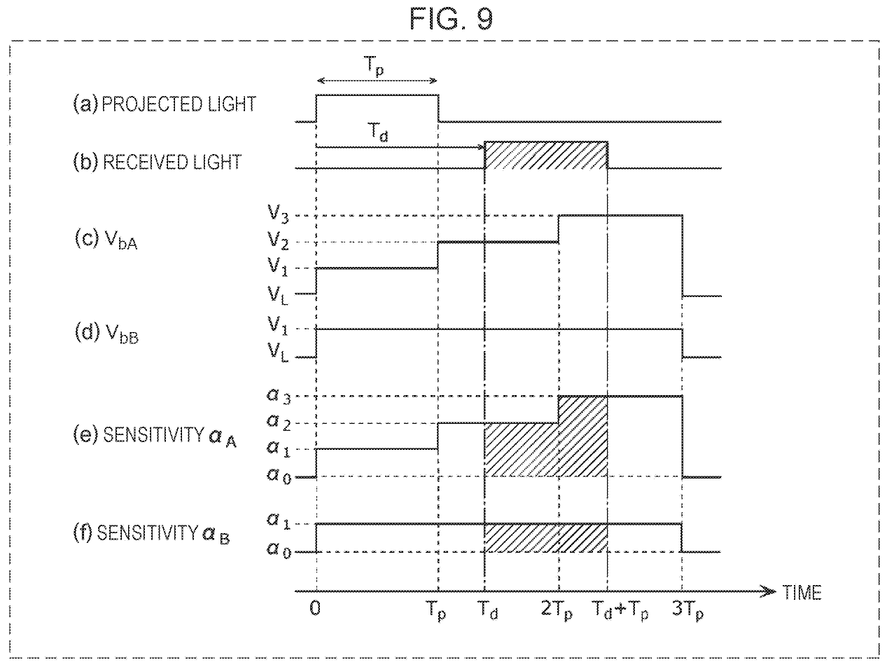

A case in which the flight time T_{d} of projected pulse light is longer than that in the example illustrated in FIG. 8 will be described below. FIG. 9 is another diagram for description of the principle of measurement of the distance to the object by the distance measurement device 100. FIG. 9 illustrates an example in which the flight time T_{d} of projected pulse light is longer than that in the example illustrated in FIG. 8, more specifically, in the range of Tₚ≤T_{d}<2Tₚ when the same drive of the pixels 10A as in FIG. 8 is performed at the distance measurement device 100. The electric charge amounts S_{A} and S_{B} accumulated at the image capturing device 120A in the example illustrated in FIG. 9 are expressed by Expressions (8) and (9) above. Specifically, the electric charge amounts S_{A} and S_{B} are calculated by Expressions (13) and (14) below.

S_{A}=Iₚₕ{(α₃−α₂)T_{d}(2α₂−α₃)Tₚ} (13)

S_{B}=Iₚₕα₁Tₚ (14)

The flight time T_{d} of projected pulse light is calculated by Expression (15) below based on Expressions (13) and (14).

$${T}_{d} = \frac{( {S}_{A} / {S}_{B} ) - ( 2 {k}_{2} - {k}_{3} )}{{k}_{3} - {k}_{2}} {T}_{p} \qquad ( 15 )$$

In the expression, k₃ is α₃/α₁ with k₃>k₂>1. In this manner, the flight time T_{d} of projected pulse light is calculated by Expression (12) in the case of 0≤T_{d}<Tₚ, and the flight time T_{d} of projected pulse light is calculated by Expression (15) in the case of Tₚ≤T_{d}<2Tₚ. Thus, the flight time T_{d} of projected pulse light in the range of 0≤T_{d}<2Tₚ can be measured by the distance measurement device 100 according to the present embodiment. The distance d from the distance measurement device 100 to the object can be calculated by Expression (2) above based on the calculated flight time T_{d}. Thus, the upper limit dₘₐₓ of distance measurable by the distance measurement device 100 according to the present embodiment is calculated by Expression (16) below.

$${d}_{max} = \frac{c \cdot 2 {T}_{p}}{2} \qquad ( 16 )$$

As understood from comparison between Expressions (3) and (16), the upper limit dₘₐₓ of distance measurable by the distance measurement device 100 according to the present embodiment is increased to distance twice as long as in the exemplary TOF scheme of the related art illustrated in FIGS. 1A and 1B for the same pulse width Tₚ of projected pulse light. Accordingly, since the upper limit dₘₐₓ of measurable distance is increased without increasing the pulse width Tₚ, the distance measurement device 100 according to the present embodiment can measure distance longer than in the related art at high distance measurement accuracy without decreasing the accuracy of distance measurement.

When the values of the sensitivity α_{A} of the variable sensitivity pixel in Expression (6), specifically, the sensitivities α₁ to α₃, and the value of the photocurrent Iₚₕ in Expression (8) are obtained, the flight time T_{d} of projected pulse light can be calculated by Expressions (10) and (13) alone based on Expressions (17) and (18), respectively.

$${T}_{d} = \frac{( {S}_{A} / {I}_{ph} ) - {α}_{1} {T}_{p}}{{α}_{2} - {α}_{1}} \qquad ( 17 )$$

$${T}_{d} = \frac{( {S}_{A} / {I}_{ph} ) - ( 2 {α}_{2} - {α}_{3} ) {T}_{p}}{{α}_{3} - {α}_{2}} \qquad ( 18 )$$

Thus, the image capturing device 120A may include no pixel 10AB as a fixed sensitivity pixel, and all pixels 10A may be pixels 10AA as variable sensitivity pixels.

When the image capturing device 120A includes fixed sensitivity pixels in addition to variable sensitivity pixels, the flight time T_{d} of projected pulse light can be calculated by Expressions (12) and (15). The values of the sensitivities α₁ to α₃ and the value of the photocurrent Iₚₕ, which are necessary for calculation of the flight time T_{d} by Expressions (17) and (18), are not used in Expressions (12) and (15). It is difficult to accurately measure the absolute values of the photocurrent Iₚₕ and the sensitivities α₁ to α₃ of variable sensitivity pixels and fixed sensitivity pixels.

In Expressions (12) and (15), k₂ and k₃ are the ratios of the light receiving sensitivity of each variable sensitivity pixel and the light receiving sensitivity of each fixed sensitivity pixel. The ratios k₂ and k₃ can be relatively easily obtained by measuring a signal amount based on signal charge accumulated in each of the variable sensitivity pixel and the fixed sensitivity pixel while changing voltage applied to the counter electrode 12 thereof and by calculating the ratio of the signal amounts. Thus, the distance measurement device 100 can calculate the flight time T_{d} of projected pulse light based only on the light receiving sensitivity ratios k₂ and k₃ and the actually measured electric charge amounts S_{A} and S_{B} of the variable sensitivity pixel and the fixed sensitivity pixel. Accordingly, the distance measurement device 100 according to the present embodiment can calculate the flight time T_{d} of projected pulse light based on the sensitivity ratios of the variable sensitivity pixel and the fixed sensitivity pixel, which can be more easily measured than the values of the sensitivities α₁ to α₃ and the value of the photocurrent Iₚₕ, and based on the electric charge amounts S_{A} and S_{B}. Moreover, measurement time reduction is possible with the distance measurement device 100 according to the present embodiment since electric charge accumulation is simultaneously performed in the variable sensitivity pixel and the fixed sensitivity pixel.

Selective use of Expressions (12) and (15) above depends on the length of the flight time T_{d} of projected pulse light in the above description, but the boundary condition of selective use of the expressions in actual use can be detected based on the electric charge amounts S_{A} and S_{B} measured at the variable sensitivity pixel and the fixed sensitivity pixel. The boundary condition is a condition with which the flight times T_{d} of projected pulse light which are calculated by Expressions (12) and (15) match each other, and is determined by Expression (19) below.

S_{A}/S_{B}=k₂ (19)

Specifically, the ratio of the measured amounts of signal charge of the variable sensitivity pixel and the fixed sensitivity pixel, that is, S_{A}/S_{B} is calculated, and Expression (12) is used when the ratio is smaller than k₂, which is the ratio of the sensitivity α₁ of the variable sensitivity pixel in the period of time point 0≤t<Tₚ and the sensitivity α₂ thereof in the period of time point Tₚ≤t<2Tₚ, or Expression (15) is used when the ratio is larger than k₂. The flight time T_{d} of projected pulse light under a condition that Expression (19) holds is T_{d}=Tₚ. Expression (15) is the same as Expression (12) when the sensitivity ratio is set such that the denominators of Expressions (12) and (15) are equal to each other, in other words, k₂−k1=k₃−k₂ holds. Thus, the flight time T_{d} can be calculated only by the same Expression (12) irrespective of the length of the flight time T_{d} of projected pulse light.

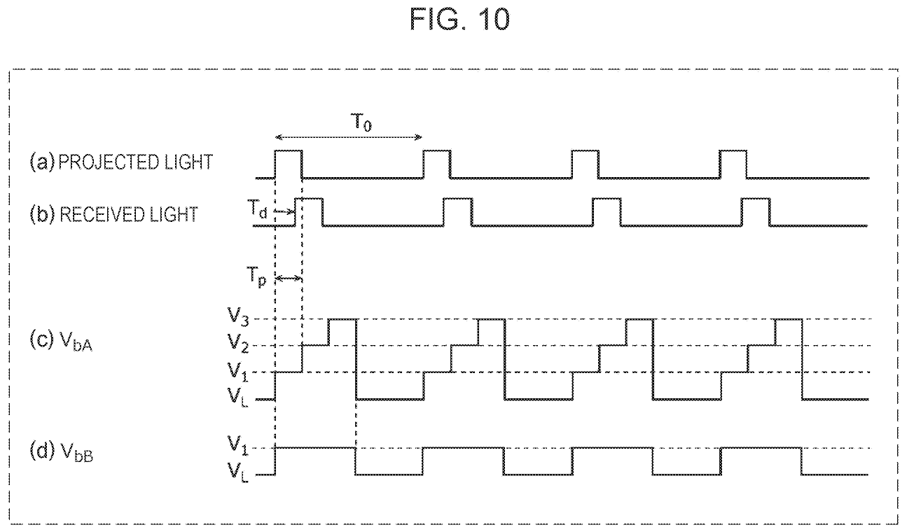

Measurement of the flight time T_{d} of projected pulse light in the distance measurement device 100 according to the present embodiment may be performed based on a plurality of values of the flight time T_{d} of projected pulse light obtained by repeating the series of drive illustrated in FIG. 5 a plurality of times. FIG. 10 is a timing chart illustrating a case in which the operation illustrated in FIG. 5 is repeated. Graphs (a) to (d) in FIG. 10 represent repetition of the operation illustrated in (a) to (d) in FIG. 5. For example, as illustrated in FIG. 10, projection of pulse light may be performed a plurality of times at the interval of a predetermined time point T₀, the flight time T_{d} may be calculated upon each projection of pulse light, and for example, the average value or median thereof may be employed as a measurement result of the flight time T_{d} of projected pulse light. The above-described predetermined time point T₀ needs to be set to be longer than the sum of: (i) a period in which the voltage V_{bA} applied to the counter electrode 12 of each variable sensitivity pixel and the voltage V_{bB} applied to the counter electrode 12 of each fixed sensitivity pixel are set to voltage other than the voltage V_{L}, for example, the length from time point 0 to time point 3Tₚ in FIG. 6; and (ii) a time taken for completing reading from all pixels 10A on the imaging plane, for example, time Tₕ in FIG. 6×the length of all pixel rows on the imaging plane. With such a measurement method, it is possible to perform distance measurement at higher accuracy with reduced influence of noise and the like.

### Modifications of Operation of Distance Measurement Device

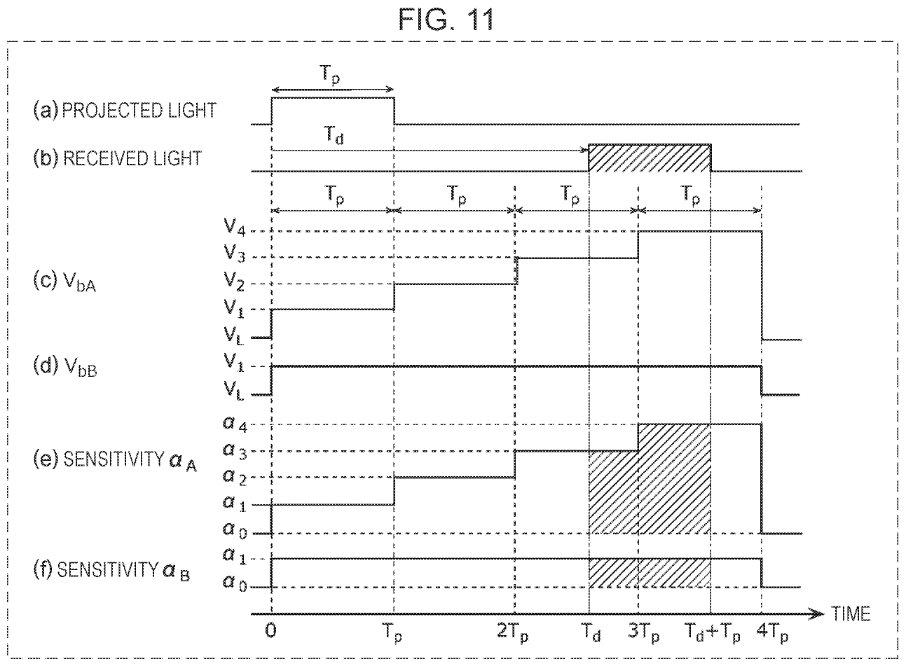

Modifications of the operation of the distance measurement device 100 according to the present embodiment will be described below. FIG. 11 is a timing chart illustrating Modification 1 of the operation of the distance measurement device 100 according to the present embodiment. In the example illustrated in FIG. 11, the voltage V_{bA} applied to the counter electrode 12 of each variable sensitivity pixel has five patterns of voltages V_{L}, V₁, V₂, V₃, and V₄, and accordingly, additionally has a period in which the sensitivity α_{A} is sensitivity α₄ corresponding to the new voltage V₄. In FIG. 11, V_{L}<V₁<V₂<V₃<V₄ holds and α₀<α₁<α₂<α₃<α₄ holds. More specifically, the voltage V_{bA} applied to the counter electrode 12 of each variable sensitivity pixel, the voltage V_{bB} applied to the counter electrode 12 of each fixed sensitivity pixel, and the sensitivities α_{A} and α_{B} of the pixels in the example illustrated in FIG. 11 are set to obey Expressions (20) to (23) below.

$${V}_{bA} = \{ \begin{matrix}{V}_{L} , & t < 0 , t \geq 4 {T}_{p} \\ {V}_{1} , & 0 \leq t < {T}_{p} \\ {V}_{2} , & {T}_{p} \leq t < 2 {T}_{p} \\ {V}_{3} , & 2 {T}_{p} \leq t < 3 {T}_{p} \\ {V}_{4} , & 3 {T}_{p} \leq t < 4 {T}_{p}\end{matrix} \qquad ( 20 )$$

$${V}_{bB} = \{ \begin{matrix}{V}_{L} , & t < 0 , t \geq 4 {T}_{p} \\ {V}_{1} , & 0 \leq t < 4 {T}_{p}\end{matrix} \qquad ( 21 )$$

$${α}_{A} = \{ \begin{matrix}{α}_{0} , & t < 0 , t \geq 3 {T}_{p} \\ {α}_{1} , & 0 \leq t < {T}_{p} \\ {α}_{2} , & {T}_{p} \leq t < 2 {T}_{p} \\ {α}_{3} , & 2 {T}_{p} \leq t < 3 {T}_{p} \\ {α}_{4} , & 3 {T}_{p} \leq t < 4 {T}_{p}\end{matrix} \qquad ( 22 )$$

$${α}_{B} = \{ \begin{matrix}{α}_{0} , & t < 0 , t \geq 4 {T}_{p} \\ {α}_{1} , & 0 \leq t < 4 {T}_{p}\end{matrix} \qquad ( 23 )$$

In the operation illustrated in FIG. 11 as well, the accumulated electric charge amounts S_{A} and S_{B} are expressed by Expressions (8) and (9) above. Thus, in the operation in FIG. 11, a calculation formula can be obtained for the flight time T_{d} of projected pulse light like Expressions (12) and (15) even when the flight time T_{d} of projected pulse light is 2Tₚ≤T_{d}<3Tₚ as illustrated in FIG. 11. The flight time T_{d} of projected pulse light in this case is calculated by Expression (24) below.

$${T}_{d} = \frac{( {S}_{A} / {S}_{B} ) - ( 3 {k}_{3} - 2 {k}_{4} )}{{k}_{4} - {k}_{3}} {T}_{p} \qquad ( 24 )$$

In the expression, k₄ is α₄/α₁ with k₄>k₃>k₂>1. The upper limit dₘₐₓ of distance measurable by the distance measurement device 100 according to the present embodiment through the operation illustrated in FIG. 11 is calculated by Expression (25) below.

$${d}_{max} = \frac{c \cdot 3 {T}_{p}}{2} \qquad ( 25 )$$

In this manner, the upper limit dₘₐₓ of measurable distance according to Expression (25) is further increased as compared to the case of Expression (16) for the same pulse width Tₚ of projected pulse light. In the operation illustrated in FIG. 11 as well, the flight time T_{d} of projected pulse light can be calculated by Expression (12) or (15) when the flight time T_{d} of projected pulse light is 0≤T_{d}<Tₚ or Tₚ≤T_{d}<2Tₚ, respectively. Similarly to the boundary condition of selective use of Expressions (12) and (15), the boundary condition of selective use of Expressions (15) and (24) can be determined based on the ratio of the amounts of signal charge in the variable sensitivity pixel and the fixed sensitivity pixel and is determined by Expression (26) below.

S_{A}/S_{B}=k₃ (26)

When the light receiving sensitivity ratio is set such that the denominator of Expression (24) is equal to the denominators of Expressions (12) and (15), in other words, k₄−k₃=k₃−k₂=k₂−1 holds, Expression (24) can be expressed completely the same as Expressions (12) and (15).

Even when the pulse width Tₚ of projected pulse light is unchanged, the upper limit dₘₐₓ of distance measurable by the distance measurement device 100 according to the present embodiment can be further increased by simply extending the operation illustrated in FIG. 11. For example, the flight time T_{d} of projected pulse light can be measured in the range of T_{d}<4Tₚ when new voltage V₅ higher than the voltage V₄ is applied to the counter electrode 12 of the variable sensitivity pixel in the period of time point 4Tₚ≤t<5Tₚ and the voltage V₁ is applied to the counter electrode 12 of the fixed sensitivity pixel for a period equal to a period in which the voltage V₅ is applied. As a result, the upper limit dₘₐₓ of measurable distance increases by the corresponding distance. Similarly, the upper limit of distance measurable by the distance measurement device 100 according to the present embodiment can be increased by increasing the number of steps to which voltage applied to the counter electrode 12 of the variable sensitivity pixel is increased, and accordingly, by extending a period in which the voltage V₁ is applied to the counter electrode 12 of the fixed sensitivity pixel.

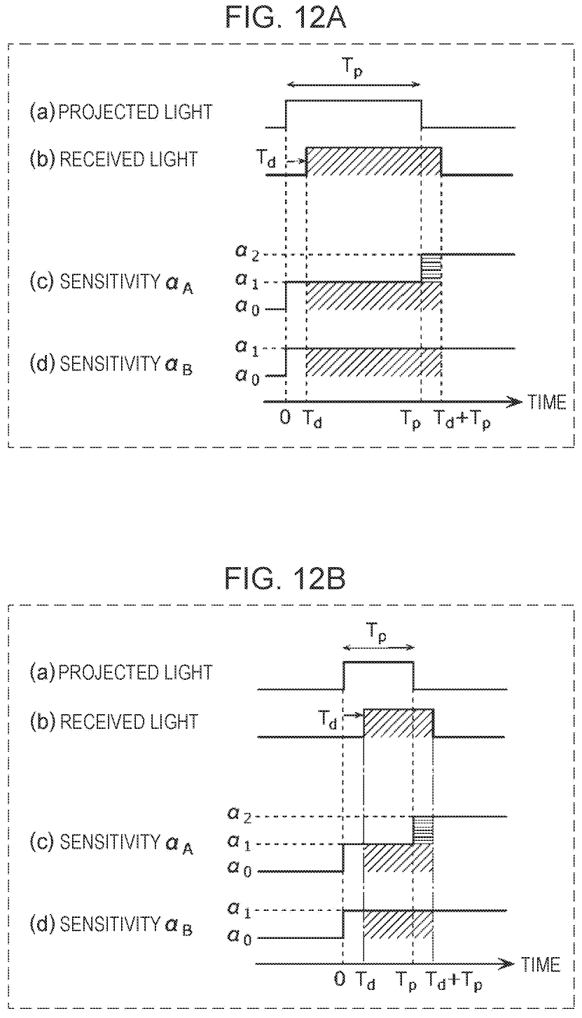

One characteristic of the distance measurement device 100 according to the present embodiment is that the upper limit dₘₐₓ of measurable distance can be increased without expanding the pulse width of pulse light projected onto the object in the TOF scheme, for example, the pulse width Tₚ in FIG. 5. In the distance measurement device 100 according to the present embodiment as well, similarly to the scheme of the related art, the upper limit dₘₐₓ of measurable distance can be increased by expanding the pulse width Tₚ of projected pulse light as indicated by Expressions (16) and (25). However, the resolution of the measured flight time of projected pulse light, for example, the flight time T_{d} in FIG. 5, in other words, the resolution of the distance to the object calculated from the flight time T_{d} degrades accordingly. This will be qualitatively described below for understanding with reference to FIGS. 12A and 12B.

FIG. 12A is a diagram illustrating the amount of reflected-light signal charge accumulated in the distance measurement device 100 when projected light is projected onto the object. FIG. 12B is a diagram illustrating the amount of reflected-light signal charge accumulated in the distance measurement device 100 when projected light having a pulse width different from that in FIG. 12A is projected onto the object. Graphs (c) and (d) in FIGS. 12A and 12B represent temporal changes of the sensitivity α_{A} of each variable sensitivity pixel and the sensitivity α_{B} of each fixed sensitivity pixel, respectively, and the area of a striped or hatched rectangular part in the graphs corresponds to the amount of signal charge accumulated when reflected light from the object is received by the image capturing device 120A.

The area of a striped rectangular part in Graph (c) in FIGS. 12A and 12B among signal charge accumulated in the variable sensitivity pixel of the image capturing device 120A changes depending on the flight time T_{d} of projected pulse light. The area of a hatched rectangular part in Graphs (c) and (d) in FIGS. 12A and 12B corresponds to signal charge accumulated in common in the variable sensitivity pixel and the fixed sensitivity pixel and changes depending on the pulse width Tₚ. The area of the hatched rectangular part matches with the electric charge amount S_{B} accumulated in the fixed sensitivity pixel. When a signal charge amount that corresponds to the area of the striped rectangular part and by which signal charge increases depending on the flight time T_{d} of projected pulse light is referred to as an electric charge amount S_{A}′, the electric charge amount S_{A} of signal charge accumulated in the variable sensitivity pixel is expressed by Expression (27) below.

S_{A}=S_{B}+S_{A}′ (27)

Expressions (12), (15), and (24) include a term of the signal charge ratio of the variable sensitivity pixel and the fixed sensitivity pixel, in other words, S_{A}/S_{B} According to Expression (27), the term of S_{A}/S_{B} can be written as Expression (28) below.

$${S}_{A} / {S}_{B} = \frac{{S}_{B} + {S}_{A}^{′}}{{S}_{B}} = 1 + \frac{{S}_{A}^{′}}{{S}_{B}} \qquad ( 28 )$$

The flight time T_{d} of projected pulse light, in other words, the electric charge amount S_{A}′ corresponding to increase in the variable sensitivity pixel depending on the flight time T_{d} of projected pulse light is the same between the example illustrated in FIG. 12A and the example illustrated in FIG. 12B. However, the electric charge amount S_{B} of the fixed sensitivity pixel is different between the examples since the pulse width Tₚ of projected light is different therebetween. More specifically, the pulse width Tₚ of projected pulse light is larger in the example illustrated in FIG. 12A than in the example illustrated in FIG. 12B, and accordingly, the electric charge amount S_{B} of the fixed sensitivity pixel is larger in the example illustrated in FIG. 12A than in the example illustrated in FIG. 12B. When Expression (28) is calculated for the example illustrated in FIG. 12A and the example illustrated in FIG. 12B, the second term S_{A}′/S_{B} on the rightmost hand side of Expression (28) is smaller in the case of FIG. 12A than in the case of FIG. 12B. This corresponds to decrease of the sensitivity of S_{A}/S_{B}, that is, the sensitivity of the flight time T_{d} of projected pulse light to change of S_{A} in the example illustrated in FIG. 12A. In other words, S_{A} that is change of the flight time T_{d} needs to be larger in the case of FIG. 12A than in the case of FIG. 12B in order to obtain a predetermined change amount of the flight time T_{d}, for example, a minimum change amount in which a measuring device can determine difference. This means that the resolutions of measurement of the flight time and measurement of the distance to the target further degrade when the pulse width Tₚ of projected pulse light is large as in the example illustrated in FIG. 12A.

As indicated by Expression (16), the upper limit dₘₐₓ of distance measurable by the distance measurement device 100 according to the present embodiment is twice as large as the pulse width Tₚ of projected pulse light in the example illustrated in FIG. 5 and can be further increased more than twice the pulse width Tₚ as in the example illustrated in FIG. 9. Accordingly, a wider range of distance measurement can be obtained without degradation of measurement resolution along with increase of the pulse width Tₚ of projected pulse light. In other words, the distance measurement device 100 can have increased accuracy of distance measurement as compared to the TOF scheme of the related art when distance measurement is performed in the same range.

In the image capturing device 120A according to the present embodiment, the pixels 10AA as variable sensitivity pixels and the pixels 10AB as fixed sensitivity pixels are alternately arrayed in the horizontal and vertical directions in the example illustrated in FIG. 3, but the present embodiment is not limited to this configuration. For example, the pixels 10AA and 10AB may be alternately arranged only in the horizontal direction and only any of pixels 10AA or pixels 10AB may be disposed in the vertical direction, in other words, on each pixel column, or the pixels 10AA and 10AB may be alternately arranged only in the vertical direction.

The three kinds of voltages V₁, V₂, and V₃ applied to the counter electrode 12 of each variable sensitivity pixel have the magnitude relation of V₁<V₂<V₃ in FIG. 5, but their magnitude relation in the distance measurement device 100 according to the present embodiment is not limited thereto. The magnitude relation may be V₁>V₂>V₃ in the distance measurement device 100 according to the present embodiment. Accordingly, the sensitivities α₁, α₂, and α₃ may have the magnitude relation of α₁>α₂>α₃. The magnitude relation of the voltage V_{bA} applied to the counter electrode 12 of each variable sensitivity pixel in the charge accumulation period needs to change only in one direction. Specifically, the voltage V_{bA} applied to the counter electrode 12 of each variable sensitivity pixel in the charge accumulation period needs to monotonically increase without decreasing or monotonically decrease without increasing as time elapses. In other words, the sensitivity α_{A} set to each variable sensitivity pixel by the control unit 130 in the charge accumulation period needs to monotonically increase without decreasing or monotonically decrease without increasing as time elapses. When such a condition is satisfied, the flight time T_{d} can be calculated as described above.

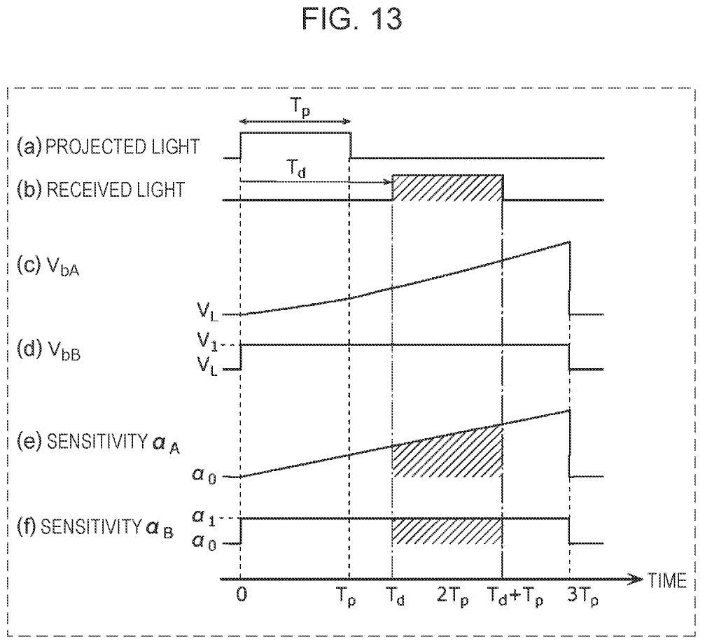

The charge accumulation period is constituted by the second, third, and fourth periods from time point 0 to time point 3Tₚ in FIG. 5 but is not limited to this configuration. The charge accumulation period may be constituted by, for example, the second and third periods from time point 0 to time point 2Tₚ. This is the same for Modification 2 of the operation to be described later with reference to FIG. 13. When the charge accumulation period is constituted by the second and third periods, for example, voltage higher than the voltage V_{L} is applied to the counter electrode 12 of each variable sensitivity pixel and the counter electrode 12 of each fixed sensitivity pixel only between time point 0 and time point 2Tₚ, and accordingly, the variable sensitivity pixel and the fixed sensitivity pixel are set to sensitivities with which signal charge can be accumulated. In a case of such operation, it is impossible to expand the range of distance measurement without increasing the pulse width Tₚ, but unlike the TOF scheme of the related art, it is not needed to distribute electric charge to two charge accumulation parts for accumulation, and thus decrease of the accuracy of distance measurement due to incomplete distribution of signal charge does not occur. Accordingly, the distance measurement device 100 can have increased accuracy of distance measurement. In this case, the length of the third period may be different from the length of the first period. To avoid narrowing of the range of distance measurement, the length of the third period is, for example, equal to or longer than the length of the first period.

The second period starts at time point 0 corresponding to the start of pulse light projection, in other words, the start time of the first period in FIG. 5, but is not limited to this configuration. The second period may start after time point 0. For example, the second period may start after time point 0 with a delay of the flight time T_{d} corresponding to the lowest value of distance to be measured. Accordingly, with the same pulse width Tₚ, the upper limit dₘₐₓ of measurable distance can be increased by an amount corresponding to the delay of start of the second period.

The voltage V_{bA} applied to the counter electrode 12 of each variable sensitivity pixel in the charge accumulation period is constant for each of the second, third, and fourth periods and changes at steps in FIG. 5, but is not limited to this configuration. The voltage V_{bA} may continuously change in the charge accumulation period. Specifically, the control unit 130 may change the sensitivity of each variable sensitivity pixel in each of the second, third, and fourth periods. FIG. 13 is a timing chart illustrating Modification 2 of the operation of the distance measurement device 100 according to the present embodiment. Graphs (a) to (f) in FIG. 13 illustrate other exemplary timing charts of items corresponding to Graphs (a) to (f) in FIG. 8, respectively.

As illustrated in (c) in FIG. 13, the voltage V_{bA} applied to the counter electrode 12 of each variable sensitivity pixel continuously increases in the charge accumulation period from time point 0 to time point 3Tₚ. Thus, as illustrated in (e) in FIG. 13, the sensitivity α_{A} of the variable sensitivity pixel continuously increases, specifically, linearly increases in the charge accumulation period. In other words, the first, second, and third sensitivities linearly increase in the second, third, and fourth periods, respectively. The first, second, and third sensitivities may linearly decrease in the second, third, and fourth periods, respectively. Alternatively, the first, second, and third sensitivities may increase or decrease at steps in the second, third, and fourth periods, respectively.

When the sensitivity α_{A} of each variable sensitivity pixel continuously changes and increases as in the case illustrated in FIG. 13, as well, the electric charge amount S_{A} accumulated in the variable sensitivity pixel is expressed by Expression (8) above. As illustrated in (d) and (f) in FIG. 13, the voltage V_{bB} applied to the counter electrode 12 of each fixed sensitivity pixel and the sensitivity as thereof are the same as those illustrated in (d) and (f) in FIG. 8, respectively. Thus, the electric charge amount S_{B} accumulated in the fixed sensitivity pixel is expressed by Expression (9) above. An expression that calculates the flight time T_{d} can be derived by rewriting Expressions (8) and (9) with the sensitivities α_{A} and α_{B} as functions of time.

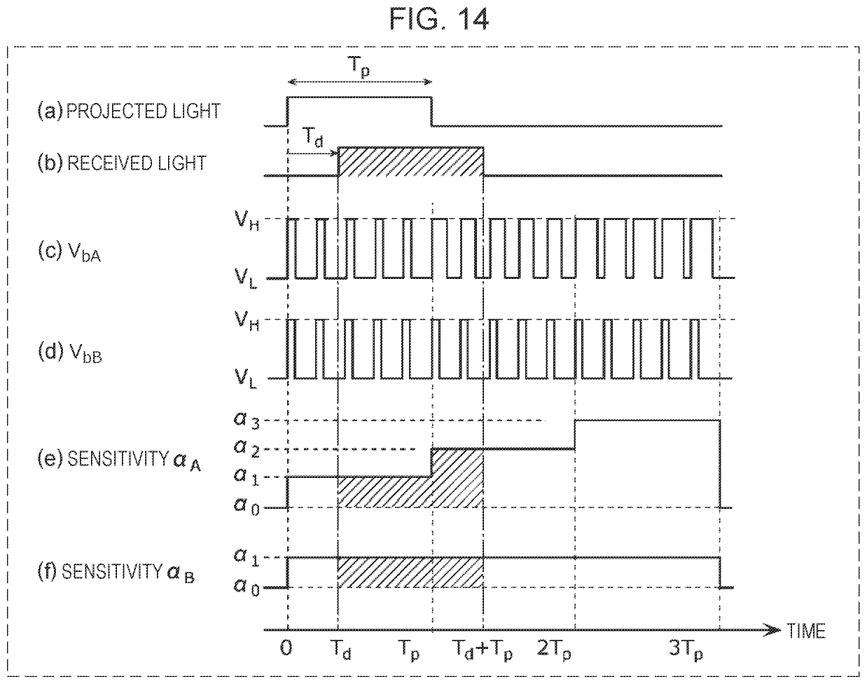

The voltage V_{bA} applied to the counter electrode 12 of each variable sensitivity pixel and the voltage V_{bB} applied to the counter electrode 12 of each fixed sensitivity pixel for setting the sensitivities of the variable sensitivity pixel and the fixed sensitivity pixel in the charge accumulation period may have an operation form in which binary pulse voltage is applied in addition to an operation form in which the magnitude of voltage is changed at steps as illustrated in FIG. 5 and an operation form in which the magnitude of voltage is continuously changed as illustrated in FIG. 13. FIG. 14 is a timing chart illustrating Modification 3 of the operation of the distance measurement device 100 according to the present embodiment. Graphs (a) to (f) in FIG. 14 illustrate other exemplary timing charts of items corresponding to Graphs (a) to (f) in FIG. 8, respectively.

As illustrated in (c) and (d) in FIG. 14, the voltage V_{bA} applied to the counter electrode 12 of each variable sensitivity pixel and the voltage V_{bB} applied to the counter electrode 12 of each fixed sensitivity pixel may be each pulse voltage that alternately repeats the two values of voltage V_{L} and predetermined voltage V_{H} higher than the voltage V_{L} in a predetermined period significantly shorter than the pulse width Tₚ. The voltage V_{L} is exemplary first voltage, and the voltage V_{H} is exemplary second voltage. Similarly to the example illustrated in FIG. 5, the voltage V_{L} is, for example, voltage with which the light receiving sensitivities of each variable sensitivity pixel and each fixed sensitivity pixel are set to the sensitivity α₀ that is substantially zero when the voltage is applied to the counter electrodes 12 thereof. The voltage V_{H} is voltage with which the light receiving sensitivities of each variable sensitivity pixel and each fixed sensitivity pixel are set to be higher than the basis sensitivity (for example, the sensitivity α₀) when the voltage is applied to the counter electrodes 12 thereof. The voltage V_{H} is, for example, the voltage V₃ in FIG. 5.

As illustrated in (c) in FIG. 14, the duty cycle of pulses of the voltage V_{bA} applied to the counter electrode 12 of each variable sensitivity pixel is different among the second, third, and fourth periods. Specifically, the ratio of the length of a period in which the voltage V_{bA} applied to the counter electrode 12 of each variable sensitivity pixel is equal to V_{H} relative to the entire length of each of the second, third, and fourth periods is different. In the example illustrated in (c) in FIG. 14, the length of the period of V_{bA}=V_{H} is shorter than the length of the period of V_{bA}=V_{L} in the second period from time point 0 to time point Tₚ, and the duty cycle of pulses of the voltage V_{bA} is, for example, 25%. The length of the period of V_{bA}=V_{H} is approximately equal to the length of the period of V_{bA}=V_{L} in the third period from time point Tₚ to time point 2Tₚ, and the duty cycle of pulses of the voltage V_{bA} is, for example, 50%. The length of the period of V_{bA}=V_{H} is longer than the length of the period of V_{bA}=V_{L} in the fourth period from time point 2Tₚ to time point 3Tₚ, and the duty cycle of pulses of the voltage V_{bA} is, for example, 75%.

In this manner, light receiving sensitivities in the second, third, and fourth periods can be differentiated by differentiating the duty cycle of pulses of the voltage V_{bA} applied to the counter electrode 12 of each variable sensitivity pixel among the periods. In other words, the control unit 130 sets the sensitivity of each variable sensitivity pixel by adjusting the duty cycle of pulse voltage applied to the photoelectrical conversion unit 13 thereof.

As illustrated in (e) in FIG. 14, for example, in the second period in which the duty cycle of pulses of the voltage V_{bA} is 25%, the sensitivity α₁ on average is 25% of that in a case in which the voltage V_{bA} is constant at the voltage V_{H}. Similarly, in the third period in which the duty cycle of pulses of the voltage V_{bA} is 50%, the sensitivity α₂ on average is 50% of that in a case in which the voltage V_{bA} is constant at the voltage V_{H}. Accordingly, the light receiving sensitivity changes in proportional to the duty cycle. Thus, the light receiving sensitivity of each variable sensitivity pixel can be changed to the sensitivities α₁, α₂, and α₃ as in (e) in FIG. 14 by changing the duty cycle of pulses of the voltage V_{bA} applied to the counter electrode 12 of the variable sensitivity pixel among the second, third, and fourth periods as in (c) in FIG. 14.

Setting of the light receiving sensitivity of each fixed sensitivity pixel can be performed similarly. The duty cycle of pulses of the voltage V_{bB} applied to the counter electrode 12 of each fixed sensitivity pixel is set to be, for example, identical to the duty cycle of pulses of the voltage V_{bA} in the second period as in (d) in FIG. 14, and the sensitivity α_{B} becomes equal to the sensitivity α₁ as illustrated in (f) in FIG. 14. The average values of the light receiving sensitivities of each variable sensitivity pixel and each fixed sensitivity pixel in each of the second, third, and fourth periods are illustrated in (e) and (f) in FIG. 14. Thus, the control unit 130 may set average light receiving sensitivities in each period as the light receiving sensitivities of each variable sensitivity pixel and each fixed sensitivity pixel.

Such adjustment of the light receiving sensitivities of each variable sensitivity pixel and each fixed sensitivity pixel not with the magnitudes of voltages applied to the counter electrodes 12 thereof but with the duty cycles of pulses of voltages makes it easy to control the light receiving sensitivities, which is an advantage. The relation between the magnitude of voltage applied to each counter electrode 12 and the light receiving sensitivity of the corresponding photoelectrical conversion unit 13 is determined by the material composition of the photoelectrical conversion unit 13 or the like and is not a proportional relation in some cases. When the relation is not a proportional relation, adjustment of the magnitude of voltage applied to the counter electrode 12 to obtain desired light receiving sensitivity is complicated in some cases. However, in a method of employing pulses of binary voltage as voltage applied to the counter electrode 12 and adjusting the light receiving sensitivity through the duty cycle thereof, the light receiving sensitivity is proportional to the duty cycle. Thus, for example, once light receiving sensitivity in a case in which the predetermined voltage V_{H} is applied to the counter electrode 12 is determined, the light receiving sensitivity can be calculated only by multiplying the determined light receiving sensitivity by the duty cycle of pulses. Accordingly, the light receiving sensitivities of each variable sensitivity pixel and each fixed sensitivity pixel can be more intuitively adjusted.

The sensitivity of only one of each variable sensitivity pixel and each fixed sensitivity pixel, for example, the sensitivity of each variable sensitivity pixel do not necessarily need to set by adjusting the duty cycle of pulse voltage applied to the photoelectrical conversion unit 13 thereof. In this case, the sensitivity of the other pixel is set by, for example, adjusting the magnitude of voltage applied to the photoelectrical conversion unit 13 thereof.

### Embodiment 2

A distance measurement device according to Embodiment 2 will be described below. The following description of Embodiment 2 will be mainly made on any difference from Embodiment 1 and omits or simplifies description of any common feature.

In Embodiment 1 described above, for example, the predetermined voltage V_{L} is applied to the counter electrode 12 of each variable sensitivity pixel and the counter electrode 12 of each fixed sensitivity pixel in the other period than the period from time point 0 to time point 3Tₚ in FIG. 5, in other words, the charge accumulation period in which any of the voltages V₁, V₂, and V₃ is applied to the counter electrode 12 of each variable sensitivity pixel and the voltage V₁ is applied to the counter electrode 12 of each fixed sensitivity pixel. The voltage V_{L} is, for example, voltage with which the sensitivity α₀ of each variable sensitivity pixel and each fixed sensitivity pixel is set to substantially zero. However, with any voltage V_{L}, the sensitivity α₀ cannot be decreased to a value that can be regarded as zero due to the material composition of each photoelectrical conversion unit 13 or the like in some cases, and each variable sensitivity pixel and each fixed sensitivity pixel inevitably have finite sensitivity α₀ in the other period than the period from time point 0 to time point 3Tₚ, that is, the above-described non-light-reception period. In such a case, signal charge generated by the sensitivity α₀ corresponding to the voltage V_{L} is added as an offset to each pixel output. The term “S_{A}/S_{B}” corresponding to the ratio of signal charge in each variable sensitivity pixel and each fixed sensitivity pixel is included in Expressions (12) and (15) that calculate the flight time T_{d} of projected pulse light in the above-described embodiment, and error due to the offset addition to the sensitivities occurs to the value of the ratio, which may degrade the accuracy of distance measurement. The distance measurement device according to the present embodiment has a configuration that can remove influence of the offset added in such a case and improve the accuracy of distance measurement.

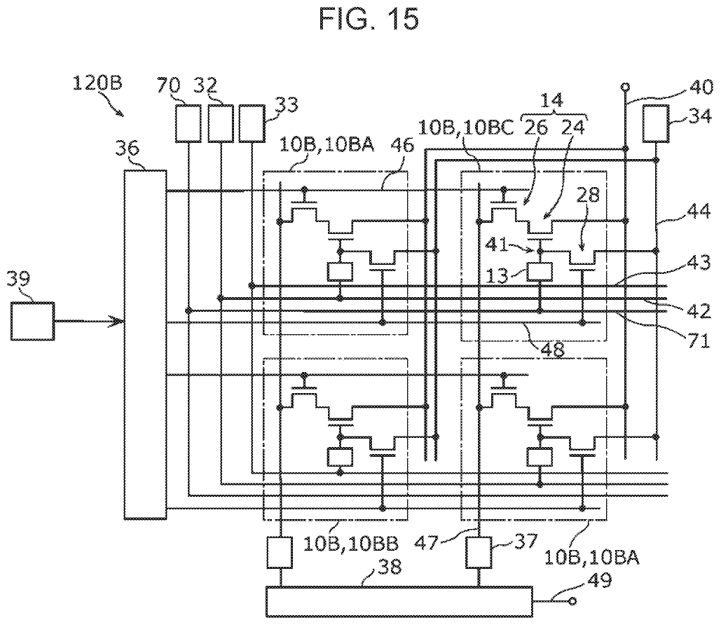

The distance measurement device 100 according to the present embodiment includes an image capturing device 120B in place of the image capturing device 120A according to Embodiment 1. FIG. 15 is a diagram illustrating an exemplary circuit configuration of the image capturing device 120B according to the present embodiment. The image capturing device 120B is different from the image capturing device 120A in Embodiment 1 illustrated in FIG. 3 in that a voltage supply circuit 70 is provided in addition to the voltage supply circuits 32 and 33 and a sensitivity control line 71 is provided in addition to the sensitivity control lines 42 and 43. The image capturing device 120B includes a plurality of pixels 10B in place of the pixels 10A.

The pixels 10B include at least one pixel 10BA, at least one pixel 10BB, and at least one pixel 10BC. The pixels 10BA, 10BB, and 10BC constitute one set of pixels disposed such that one pixel in the set of pixels is adjacent to at least another pixel in the set of pixels. Although not illustrated, for example, the pixels 10BA, 10BB, and 10BC of a set are arranged on the same pixel row when the pixel array illustrated in FIG. 15 is extended to three columns or more. In the present embodiment, the pixel 10BA is an exemplary first pixel, the pixel 10BB is an exemplary second pixel, and the pixel 10BC is an exemplary third pixel. The pixel 10BA has the same configuration as, for example, the pixel 10AA, and the pixel 10BB has the same configuration as, for example, the pixel 10AB. In the following description, the pixels 10BA, 10BB, and 10BC are collectively referred to as pixels 10B in some cases when not needing to be distinguished from one another.

The pixel 10BC has the same configuration as the pixels 10BA and 10BB except that the pixel 10BC is connected to the sensitivity control line 71. Specifically, the photoelectrical conversion unit 13 of the pixel 10BC is connected to the sensitivity control line 71.

The sensitivity control line 71 is connected to the counter electrode 12 of the pixel 10BC. The sensitivity control line 71 is connected to the voltage supply circuit 70. The voltage supply circuit 70 supplies, to the sensitivity control line 71, voltage different from that to the voltage supply circuits 32 and 33. Accordingly, the voltage supply circuit 70 controls the potential of the counter electrode 12 relative to the pixel electrode 11 in the pixel 10BC.

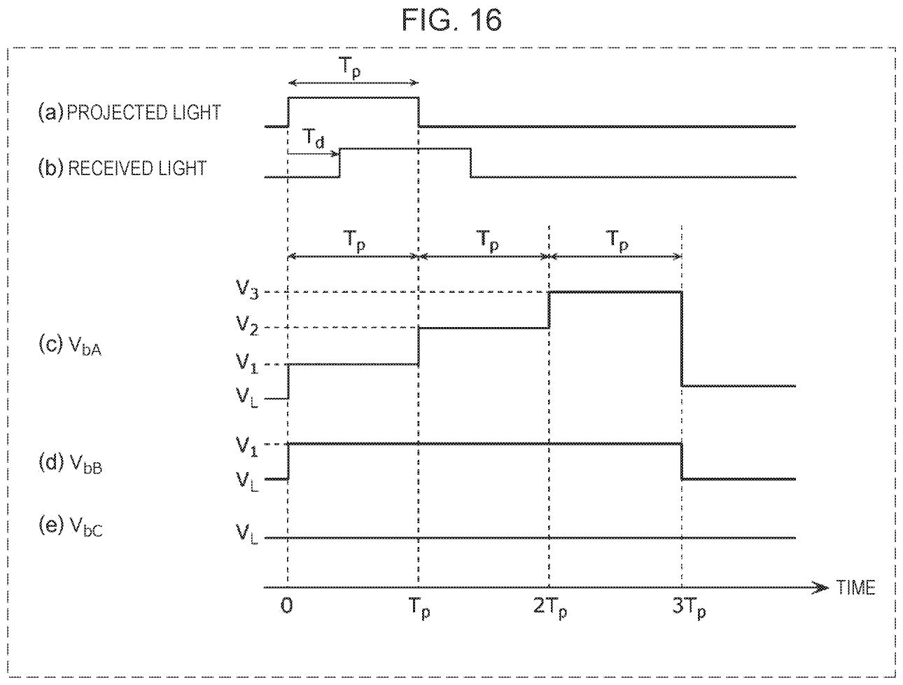

FIG. 16 is a timing chart illustrating exemplary operation of the distance measurement device 100 according to the present embodiment. Graphs (a) to (d) in FIG. 16 are identical to Graphs (a) to (d) in FIG. 5. Voltage V_{bC} is supplied to the sensitivity control line 71 from the voltage supply circuit 70 newly added in the distance measurement device 100 the image capturing device 120B according to the present embodiment. Graph (e) in FIG. 16 illustrates temporal change of the voltage V_{bC} supplied from the voltage supply circuit 70 to the counter electrode 12 of the pixel 10BC connected through the sensitivity control line 71. As illustrated in (e) in FIG. 16, the voltage V_{bC} is set to the voltage V_{L} at any time point. Electric charge acquired with the sensitivity α₀ corresponding to the voltage V_{L} is accumulated in the pixel 10BC supplied with the voltage V_{bC}, and the electric charge accumulated in the pixel 10BC corresponds to the above-described offset component. The pixel 10BC to the counter electrode 12 of which the voltage V_{bC} is applied is referred to as an offset pixel. In this manner, the control unit 130 sets the sensitivity of the offset pixel to the sensitivity α₀ in the entire period including the charge accumulation period. When the amount of signal charge accumulated in the offset pixel is referred to as an electric charge amount S_{C}, expressions for calculating the flight time T_{d} of projected pulse light, specifically, Expressions (12) and (15) in Embodiment 1 can be rewritten Expressions (29) and (30) below by using the electric charge amounts S_{A}, S_{B}, and S_{C}.

$${T}_{d} = \frac{( \frac{{S}_{A} - {S}_{C}}{{S}_{B} - {S}_{C}} ) - 1}{{k}_{2} - 1} {T}_{p} \qquad ( 29 )$$

$${T}_{d} = \frac{( \frac{{S}_{A} - {S}_{C}}{{S}_{B} - {S}_{C}} ) - ( 2 {k}_{2} - {k}_{3} )}{{k}_{3} - {k}_{2} )} {T}_{p} \qquad ( 30 )$$

When reading is sequentially performed from a plurality of pixels 10B as illustrated in FIG. 6 in Embodiment 1 described above, the start and end time points of the charge accumulation period are the same among all pixels 10B, but the start and end time points of the pixel reading period are different among pixel rows. As a result, the length of the blanking period from the end time point of the charge accumulation period to the start time of the pixel reading period is different among pixel rows. In the present embodiment, since each pixel 10B has the finite sensitivity α₀ in the blanking period, signal charge is accumulated in the period as well, and the amount of accumulated electric charge is different among pixel rows. Influence of the difference in the length of the blanking period among pixel rows can be reduced by, for example, calculation as described below for the terms “S_{A}−S_{C}” and “S_{B}−S_{C}” in Expressions (29) and (30). For example, the calculation is performed by using the amounts of signal charge in a variable sensitivity pixel and an offset pixel that are disposed on the same pixel row and the amounts of signal charge in a fixed sensitivity pixel and an offset pixel that are disposed on the same pixel row. Since reading time points of pixels 10B disposed on the same pixel row are identical, the length of the blanking period is identical among a variable sensitivity pixel, a fixed sensitivity pixel, and an offset pixel disposed on the same pixel row. Thus, the difference in the length of the blanking period among pixel rows can be canceled by calculating Expressions (29) and (30) by using the amounts of signal charge in pixels 10B disposed on the same pixel row, and accordingly, influence of the difference can be reduced.

With the configuration of the image capturing device 120B according to the present embodiment, even when the light receiving sensitivity of each pixel 10B upon application of the voltage V_{L} to the image capturing device 120B cannot be regarded as zero, influence thereof can be reduced and distance measurement can be performed at higher accuracy.

### Embodiment 3

A distance measurement device according to Embodiment 3 will be described below. The following description of Embodiment 3 will be mainly made on any difference from Embodiments 1 and 2 and omits or simplifies description of any common feature. The distance measurement device according to the present embodiment temporally switches patterns of voltage application to one pixel instead of performing image capturing with a plurality of pixels to the counter electrodes 12 of which voltage is applied in different patterns.

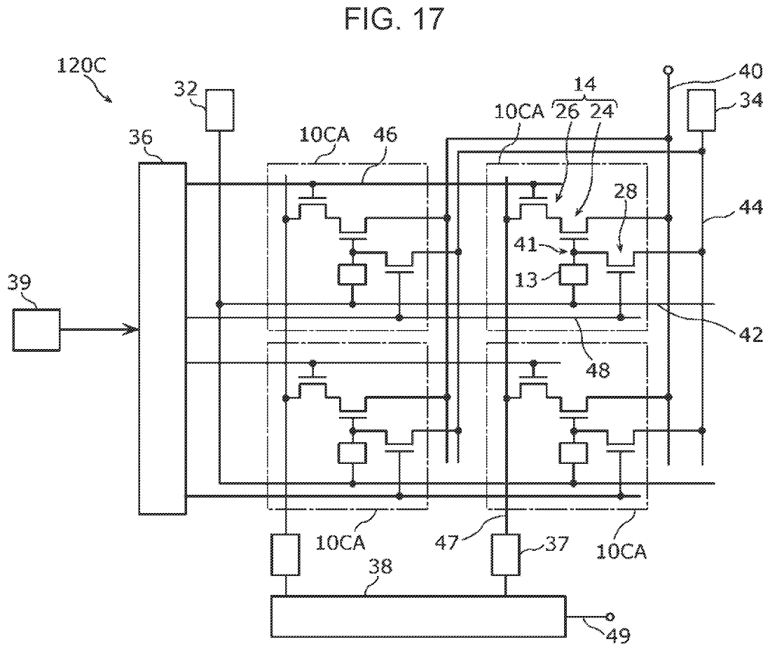

In the present embodiment, the distance measurement device 100 includes, in place of the image capturing device 120A according to Embodiment 1, an image capturing device 120C having a configuration and a drive method that are different from those of the image capturing device 120A. FIG. 17 is a diagram illustrating an exemplary circuit configuration of the image capturing device 120C according to the present embodiment. The image capturing device 120C is different from the image capturing device 120A in that the image capturing device 120C includes a plurality of pixels 10CA in place of the pixels 10A in the image capturing device 120A. In the present embodiment, the pixels 10CA are exemplary first pixels. Difference of the image capturing device 120C from the circuit configuration of the image capturing device 120A illustrated in FIG. 3 in Embodiment 1 is such that the image capturing device 120C includes no voltage supply circuit 33 nor sensitivity control line 43 and the same voltage is supplied from the voltage supply circuit 32 to the counter electrodes 12 of all pixels 10CA through the sensitivity control line 42. Each pixel 10CA has, for example, the same device configuration as each pixel 10A illustrated in FIG. 4. The same voltage is supplied to the counter electrodes 12 of all pixels 10CA, and thus the counter electrode 12 may be formed across two adjacent pixels 10CA or may be formed across all pixels 10CA.

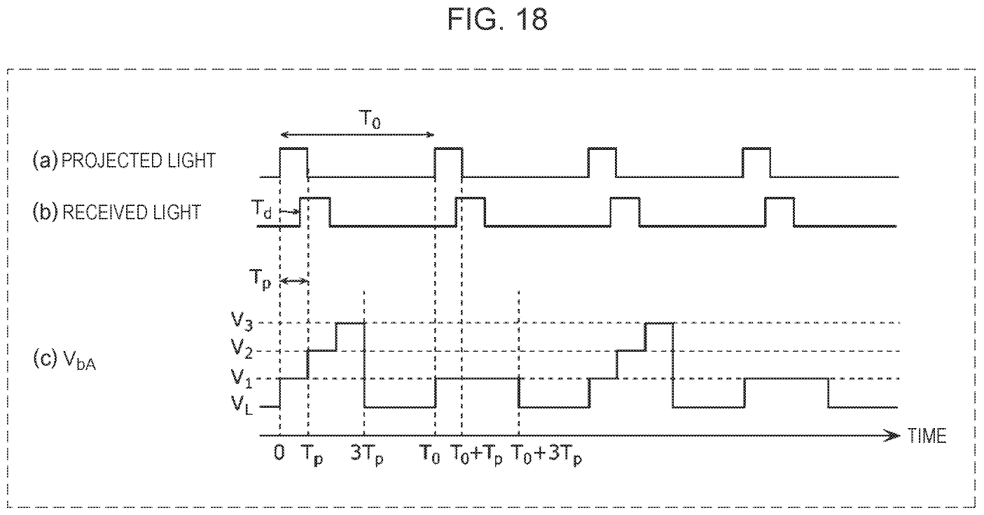

An exemplary drive method of the distance measurement device 100 according to the present embodiment will be described below. FIG. 18 is a timing chart illustrating exemplary operation of the distance measurement device 100 according to the present embodiment. Graphs (a) to (c) in FIG. 18 illustrate exemplary timing charts of items corresponding to Graphs (a) to (c) in FIG. 5, respectively. In the image capturing device 120C according to the present embodiment, the same voltage V_{bA} is supplied to all pixels 10CA. As illustrated in (a) in FIG. 18, the light source 140 projects pulse light a plurality of times at the interval of time point T₀. The plurality of pulses of projected light from the light source 140 have the same pulse width Tₚ. In the example illustrated in FIG. 18, the light source 140 performs first projection of first pulse light in the period of the pulse width Tₚ from time point 0 and performs second projection of second pulse light in the period of the pulse width Tₚ from time point T₀, in other words, until time point T₀+Tₚ after the projection of the first pulse light ends. The period of the pulse width Tₚ from time point T₀ is an exemplary fifth period.

As illustrated in (c) in FIG. 18, the voltage supply circuit 32 according to the present embodiment supplies voltages different from each other in a plurality of charge accumulation periods corresponding to the plurality of times of projection of pulse light. Specifically, in the charge accumulation period of odd-numbered pulse light projection in the example illustrated in FIG. 18, the voltage supply circuit 32 supplies voltage that increases to the voltage V₁, V₂, or V₃ in the stated order at each pulse width Tₚ of projected light, that is, the same voltage to each variable sensitivity pixel, which is described above with reference to FIG. 5. In the charge accumulation period of even-numbered pulse light projection, the voltage supply circuit 32 supplies the constant voltage V 1, that is, the same voltage to each fixed sensitivity pixel, which is described above with reference to FIG. 5. In addition to such sensitivity settings in the charge accumulation period described above with reference to FIG. 5, the control unit 130 sets the sensitivity of each pixel 10CA to the reference sensitivity in the charge accumulation period starting at time point T₀. The charge accumulation period from time point T₀ to time point T₀+3Tₚ is an exemplary second light-reception period. The second light-reception period may start after time point T₀ for the same reason as the above-described first period. In this case, the time difference between time point 0 and the start time of the first period is equal to the time difference between time point T₀ and the start time of the second light-reception period.

Through such operation, the electric charge amount S_{A} in Expressions (12) and (15), which corresponds to a signal from each variable sensitivity pixel, is measured at odd-numbered pulse light projection, and the electric charge amount S_{B} corresponding to a signal from each fixed sensitivity pixel is measured at even-numbered pulse light projection. Then, the flight time T_{d} of projected pulse light is calculated by using the measurement results by the same method as in Embodiment 1.

The first light-reception period is earlier than the second light-reception period in the example illustrated in FIG. 18 but may be later than the second light-reception period.

With the configuration of the distance measurement device 100 according to the present embodiment, the distance to the object can be measured in a state in which the same voltage is applied to all pixels 10CA on the imaging plane. In other words, with the configuration, the counter electrodes 12 do not need to be separately disposed for the respective pixels 10CA, and a common counter electrode 12 may be disposed for all pixels 10CA on the imaging plane.

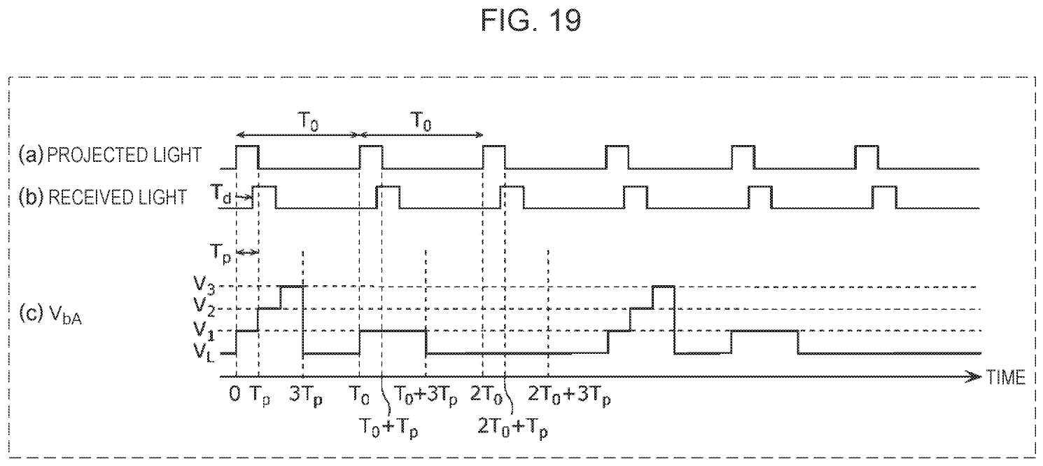

The offset component removal by the image capturing device 120B according to Embodiment 2 can be achieved by extending the operation according to the present embodiment. FIG. 19 is a timing chart illustrating a modification of the operation of the distance measurement device 100 according to the present embodiment. Graphs (a) to (c) in FIG. 19 illustrate exemplary timing charts of items corresponding to Graphs (a) to (c) in FIG. 5, respectively.

As illustrated in (a) in FIG. 19, the light source 140 performs third projection of, in addition to the first pulse light and the second pulse light described above with reference to FIG. 18, third pulse light in the period of the pulse width Tₚ from time point 2T₀ later than the end of projection of the second pulse light, in other words, until time point 2T₀+Tₚ. The period of the pulse width Tₚ from time point 2T₀ is an exemplary sixth period.

As illustrated in (c) in FIG. 19, the voltage supply circuit 32 supplies the same voltage V_{bA} to all pixels 10CA of the image capturing device 120C and changes the voltage V_{bA} at each pulse light projection onto the object. Specifically, for example, in the (3n+1)-th pulse light projection, the voltage supply circuit 32 applies, to the counter electrode 12 of each pixel 10CA on the imaging plane, the same voltage as that to each variable sensitivity pixel described above with reference to FIG. 5. For example, in the (3n+2)-th pulse light projection, the voltage supply circuit 32 applies, to the counter electrode 12 of each pixel 10CA on the imaging plane, the same voltage as that to each fixed sensitivity pixel described above with reference to FIG. 5. For example, in the 3(n+1)-th pulse light projection, the voltage supply circuit 32 applies, to the counter electrode 12 of each pixel 10CA on the imaging plane, the same voltage as that to each offset pixel described above with reference to FIG. 16. The number n is an integer equal to or larger than zero. In addition to such sensitivity setting of each pixel 10CA described above with reference to FIG. 18, the control unit 130 sets the sensitivity of each pixel 10CA to the basis sensitivity in the charge accumulation period starting at time point 2T₀. The charge accumulation period from time point 2T₀ to time point 2T₀+3Tₚ is an exemplary third light-reception period. The third light-reception period may start after time point 2T₀ for the same reason as the above-described first period. In this case, the time difference between time point 0 and the start time of the first period is equal to the time difference between time point 2T₀ and the start time of the third light-reception period. Expressions (28) and (29) above are calculated based on the amounts of signal charge obtained through these three times of pulse light projection, that is, the amounts of electric charge corresponding to the electric charge amounts S_{A}, S_{B}, and S_{C}, and accordingly, the flight time T_{d} is calculated.

### Embodiment 4

A distance measurement device according to Embodiment 4 will be described below. The following description of Embodiment 4 will be mainly made on any difference from Embodiments 1 to 3 and omits or simplifies description of any common feature.

Each photoelectrical conversion unit of an image capturing device of the distance measurement device 100 in the present disclosure only needs to include means for changing light receiving sensitivity as illustrated in FIGS. 8 and 9 and is not limited to a photoelectrical conversion unit 13 including the photoelectric conversion layer 15 as illustrated in FIGS. 3 and 4. For example, the photoelectrical conversion unit may be a photodiode.

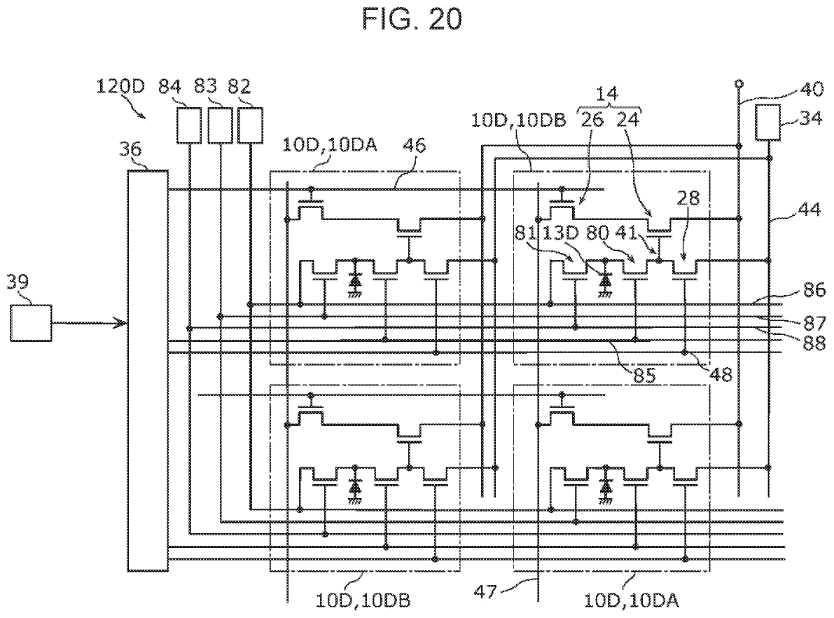

The distance measurement device 100 according to the present embodiment includes an image capturing device 120D in place of the image capturing device 120A according to Embodiment 1. FIG. 20 is a diagram illustrating an exemplary circuit configuration of the image capturing device 120D according to the present embodiment. The image capturing device 120D according to the present embodiment is different from the image capturing device 120A, 120B, and 120C according to Embodiments 1 to 3 in that the image capturing device 120D includes a photodiode 13D, a transfer transistor 80, a charge discharging transistor 81, a voltage supply circuit 82, a voltage supply circuit 83, a voltage supply circuit 84, a transfer control line 85, a charge discharging voltage line 86, a charge discharging control line 87, and a charge discharging control line 88. The image capturing device 120D includes a plurality of pixels 10D. The pixels 10D include at least one pixel 10DA and at least one pixel 10DB. The pixels 10DA and 10DB are disposed adjacent to each other as one set of pixels. The pixel 10DA is an exemplary first pixel, and the pixel 10DB is an exemplary second pixel. In FIG. 20, any component substantially identical to that in FIG. 5 is denoted by the same reference sign as in FIG. 5.

The photodiode 13D in the image capturing device 120D receives projected pulse light reflected by the object and generates and accumulates electric charge in an amount in accordance with the intensity thereof through photoelectric conversion. In a case described in the present embodiment, the photodiode 13D generates and accumulates negative electric charge upon light reception.

One of the source and drain of the transfer transistor 80 is connected to the photodiode 13D, and the other is connected to the corresponding charge accumulation node 41. The gate of the transfer transistor 80 is connected to the transfer control line 85. The transfer control line 85 is connected to the vertical scanning circuit 36 like the address control line 46 and the reset control line 48. The transfer control line 85 establishes conduction through the transfer transistor 80 upon application of predetermined potential from the vertical scanning circuit 36 and transfers electric charge generated and accumulated in the photodiode 13D to the charge accumulation node 41.

One of the source and drain of the charge discharging transistor 81 is connected to the photodiode 13D, and the other is connected to the charge discharging voltage line 86. The gate of the charge discharging transistor 81 is connected to the charge discharging control line 87 or the charge discharging control line 88. Specifically, the gate of the charge discharging transistor 81 of the pixel 10DA is connected to the charge discharging control line 87, and the gate of the charge discharging transistor 81 of the pixel 10DB is connected to the charge discharging control line 88.

The potential of the charge discharging control line 87 is controlled by the voltage supply circuit 83, and the potential of the charge discharging control line 88 is controlled by the voltage supply circuit 84. In each of the pixels 10DA and 10DB, electric charge accumulated in the photodiode 13D is discharged to the voltage supply circuit 82 through the charge discharging voltage line 86 in accordance with the magnitude of the potential of the charge discharging control line 87 or 88. For example, the power voltage VDD is supplied from the voltage supply circuit 82 to the charge discharging voltage line 86.

For example, the pixel 10DA is a variable sensitivity pixel, and the pixel 10DB is a fixed sensitivity pixel. Accordingly, the charge discharging control line 87 and the voltage supply circuit 83 are connected to the charge discharging transistor 81 of the variable sensitivity pixel. The charge discharging control line 88 and the voltage supply circuit 84 are connected to the charge discharging transistor 81 of the fixed sensitivity pixel. As the potential of the charge discharging control line 87 or 88 is increased, the amount of electric charge discharged to the charge discharging voltage line 86 increases and the amount of electric charge transferred to the corresponding charge accumulation node 41, in other words, the amount of pixel signal charge to be finally read decreases. An equivalent state in which light receiving sensitivity is decreased can be achieved by adjusting the potential of the charge discharging control line 87 or 88 and discharging electric charge at a predetermined ratio relative to the amount of electric charge accumulated in the corresponding photodiode 13D. Thus, the same change of light receiving sensitivity as that of the sensitivities α_{A} and α_{B} illustrated in (e) and (f) in FIG. 8 in Embodiment 1 described above is achieved by controlling the potential of the charge discharging control line 87 or 88 to control the amount of electric charge discharged from the corresponding photodiode 13D. In the present embodiment, sensitivity setting by such equivalent control of light receiving sensitivity is included in the meaning of “sensitivity setting”.

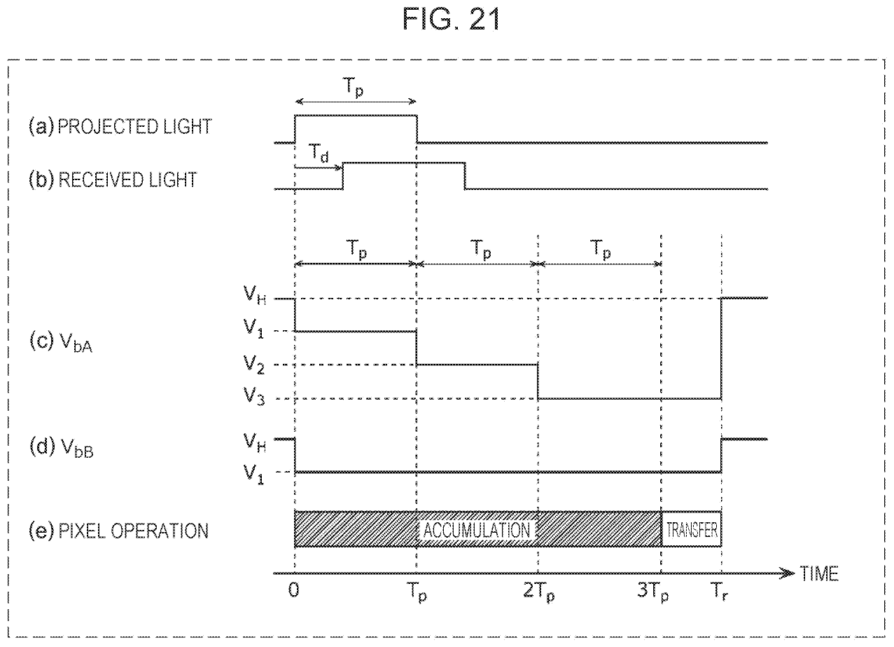

The operation of the distance measurement device 100 according to the present embodiment is performed, for example, as illustrated in FIG. 21. FIG. 21 is a timing chart illustrating exemplary operation of the distance measurement device 100 according to the present embodiment. Graphs (a) and (b) in FIG. 21 are identical to Graphs (a) and (b) in FIG. 5. Graph (c) in FIG. 21 illustrates exemplary potential V_{bA} of the charge discharging control line 87 connected to a variable sensitivity pixel. In (c) in FIG. 21, the voltage supply circuit 83 sets the potential V_{bA} of the charge discharging control line 87 to predetermined voltage V_{H} before time point 0. The voltage V_{H} is equal to voltage with which all electric charge accumulated in the photodiode 13D is discharged to the charge discharging voltage line 86, for example, the power voltage VDD. Thus, no electric charge is accumulated in the photodiode 13D in this period, and equivalent light receiving sensitivity as exemplary basis sensitivity when the potential V_{bA} is set to the voltage V_{H} is substantially zero. Thereafter, the voltage supply circuit 83 sequentially decreases the potential V_{bA} of the charge discharging control line 87 to the voltage V₁, V₂, or V₃ in the stated order at each elapse of the pulse width Tₚ from time point 0. The equivalent light receiving sensitivity of the pixel 10D in the image capturing device 120D is increased as the potential of the charge discharging control line 87 is decreased as described above. Thereafter, at time point Tᵣ later than time point 3Tₚ, the voltage supply circuit 83 sets the potential of the charge discharging control line 87 to the voltage V_{H} again to return to a state in which all electric charge is discharged from the photodiode 13D, in other words, the equivalent light receiving sensitivity of the pixel 10D is substantially zero.

Graph (d) in FIG. 21 illustrates exemplary potential of the charge discharging control line 88 connected to a fixed sensitivity pixel. In (d) in FIG. 21, the voltage supply circuit 84 sets the potential V_{bB} of the charge discharging control line 88 to the voltage V₁ in the period from time point 0 to Tᵣ and sets the potential V_{bB} to the voltage V_{H} in the other period.

Graph (e) in FIG. 21 schematically illustrates the timing of reading operation at each pixel 10D of the image capturing device 120D according to the present embodiment. In the period of a white rectangle denoted by “transfer” in (e) in FIG. 21, the potential V_{bA} of the charge discharging control line 87 in each variable sensitivity pixel is sequentially changed to the voltage V₁, V₂, or V₃ at a predetermined time width, and then conduction through the transfer transistor 80 is established to transfer electric charge accumulated in the corresponding photodiode 13D to the corresponding charge accumulation node 41. In the example illustrated in FIG. 21, the predetermined time width is the pulse width Tₚ of projected pulse light. Time point Tᵣ in (c) and (d) in FIG. 21, at which the potential of the charge discharging control line 87 and the potential of the charge discharging control line 88 are changed from the voltage V₃ and the voltage V₁, respectively, to the voltage V_{H}, is a time point after completion of the electric charge transfer by the transfer transistor 80 in (e) in FIG. 21. Electric charge at the charge accumulation node 41 may be reset by using the reset transistor 28 of the pixel 10D before the electric charge transfer using the transfer transistor 80.

With the configuration of the image capturing device 120D according to the present embodiment, the distance measurement device 100 according to the present embodiment including the image capturing device 120D including no photoelectric conversion layer can have increased accuracy of distance measurement.

### Embodiment 5

Embodiment 5 will be described below. It can be written that the distance measurement devices according to Embodiments 1 to 4 described above detect the phase difference between projected light and received light by measuring the flight time T_{d}, which is a shift from time point T₀ at which projection of pulses of the projected light is started. In Embodiment 5, the same phase detection device as those of Embodiment 1 and the other embodiments, which includes the detector 120 and the control unit 130, will be described. The following description of Embodiment 5 will be mainly made on any difference from Embodiments 1 to 4 and omits or simplifies description of any common feature.

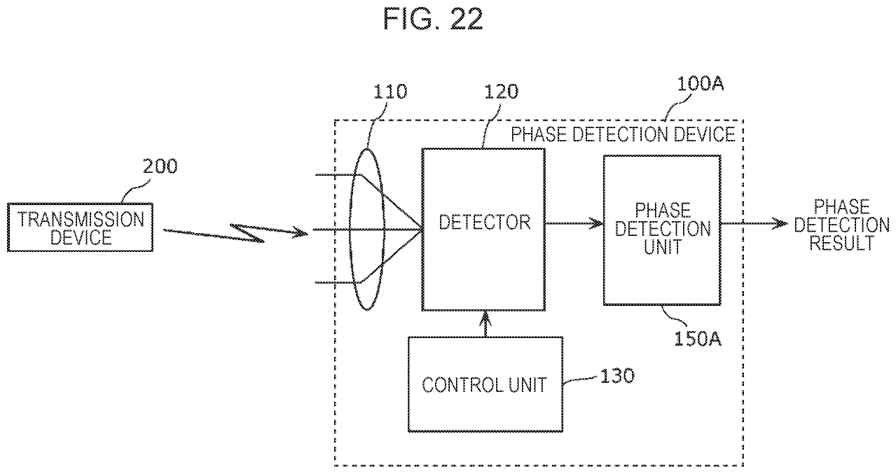

The following describes, with reference to FIGS. 22 to 24, an example in which a phase detection device 100A according to the present embodiment is used as a reception device in optical communication. FIG. 22 is a block diagram illustrating an exemplary configuration of the phase detection device according to the present embodiment. As illustrated in FIG. 22, the phase detection device 100A according to the present embodiment includes the lens optical system 110, the detector 120, the control unit 130, and a phase detection unit 150A. The phase detection device 100A according to the present embodiment detects, for example, the phase difference of pulse light from a transmission device 200. For example, transmission data is emitted from the transmission device 200 in a wired or wireless manner through phase modulation of a sequence of pulse light having a predetermined period, a phase modulation signal of the pulse light is detected by the phase detection device 100A, and the phase-modulated transmission data is demodulated. The pulse light thus used is, for example, infrared light.

The detector 120 is, for example, any of the above-described image capturing devices 120A to 120D. Similarly to the above-described distance measurement device 100, operation of the detector 120 is controlled by the control unit 130. The phase detection unit 150A outputs a result of phase detection based on an output signal from the detector 120. The result of phase detection is, for example, transmission data obtained by demodulating a detected phase modulation signal. The phase detection unit 150A may calculate a delay time from a reference time by the same method as the above-described distance measurement method and may output a result of the calculation. The start time of projection of projected pulse light in the above-described distance measurement method corresponds to the reference time, and the time of flight in the above-described distance measurement method corresponds to the delay time.

The phase detection device 100A may include no phase detection unit 150A, and the detector 120 may output an output signal to the outside.

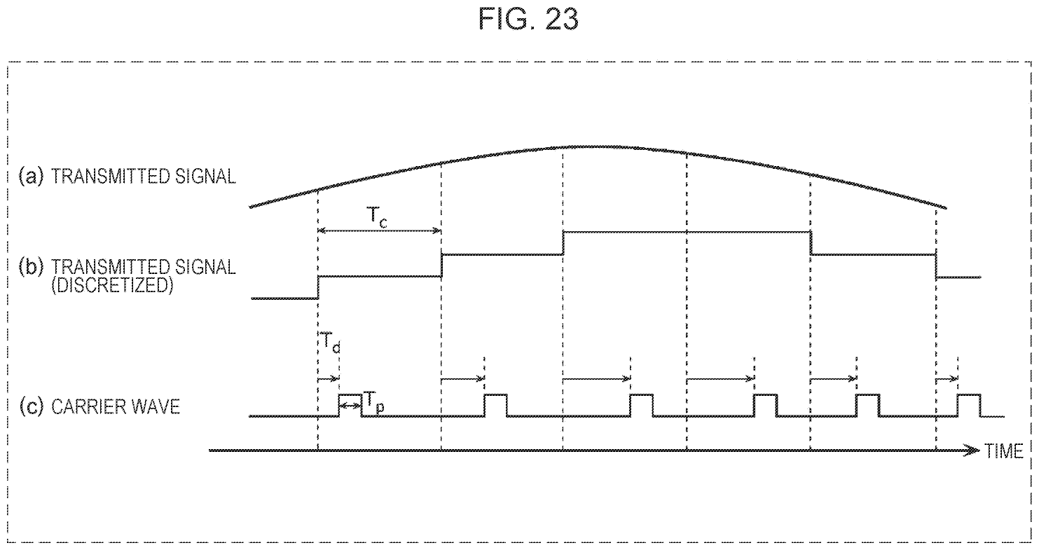

FIG. 23 is a diagram illustrating exemplary signals sent by the transmission device. In the example in the present embodiment, when transmitting a signal having a signal level that temporally changes as illustrated in (a) in FIG. 23, the transmission device 200 emits a sequence of pulse light that has the pulse width Tₚ and the magnitude of a delay time of which from a reference time is proportional to the magnitude of the transmitted signal as illustrated in (c) in FIG. 23, instead of directly transmitting the signal waveform of (a) or (b) in FIG. 23. In the present embodiment, the delay time from the reference time is also referred to as phase difference, and the sequence of phase-modulated pulse light is also referred to as carrier wave.

More specifically, the transmission device 200 samples transmission data having the level change illustrated in (a) in FIG. 23 in a predetermined period T_{c} as illustrated in (b) in FIG. 23. Then, the transmission device 200 emits, as carrier wave, a sequence of pulse light having a delay time T_{d} proportional to a signal level sampled in each period of the period T_{c} as illustrated in (c) in FIG. 23. Specifically, pulse light having the pulse width Tₚ and repeatedly emitted from the transmission device 200 is emitted in each period T_{c} with a delay of a time in accordance with the signal level from the reference time at the interval of the period T_{c}.

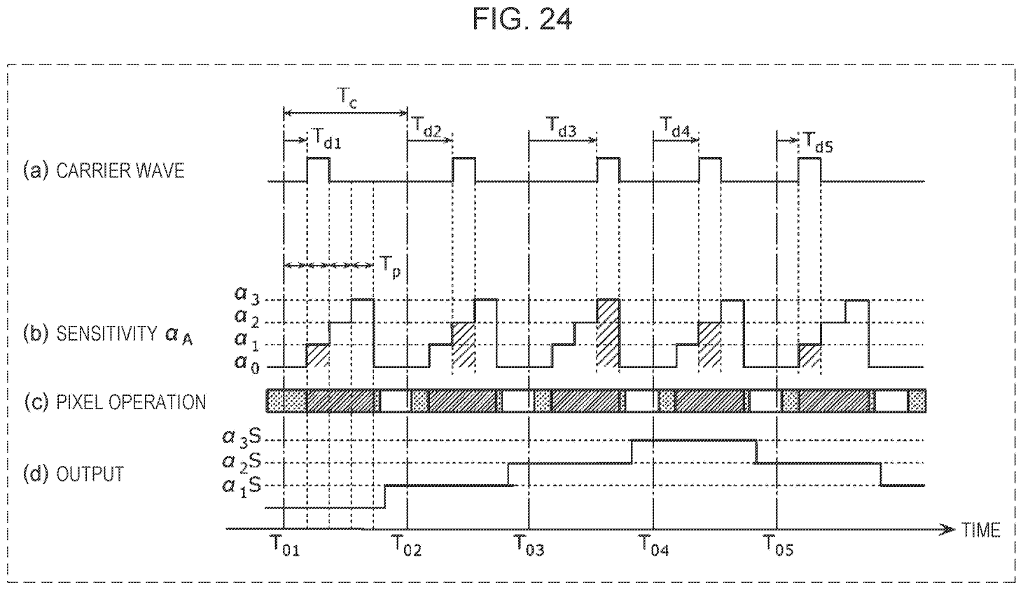

Similarly to the distance measurement device 100 in the above-described embodiments and modifications, the phase detection device 100A according to the present embodiment divides the charge accumulation period into periods and detects the carrier wave illustrated in (c) in FIG. 23 at light receiving sensitivity sequentially changed in each period. FIG. 24 is a timing chart illustrating exemplary operation of the phase detection device 100A according to the present embodiment. Similarly to Graph (c) in FIG. 23, Graph (a) in FIG. 24 illustrates temporal change of the carrier wave. Similarly to Graph (e) in FIG. 8, Graph (b) in FIG. 24 illustrates temporal change of light receiving sensitivity obtained at each variable sensitivity pixel. Similarly to Graph (e) in FIG. 5, Graph (c) in FIG. 24 schematically illustrates the timings of electric charge accumulation and reading operation at each pixel 10A. Thus, rectangles illustrated in (c) in FIG. 24 are provided with the same patterns as in (e) in FIG. 5 and represent the charge accumulation period (hatched), the pixel reading period (white), and the blanking period (dotted). Graph (d) in FIG. 24 illustrates temporal change of a signal level detected by the phase detection device 100A.

In the example illustrated in (a) in FIG. 24, each pulse light of the carrier wave is emitted with a delay of a predetermined time from a reference time in the corresponding period T_{c}. In the example illustrated in FIG. 24, the reference times are time points T₀₁, T₀₂, T₀₃, . . . , which are the start time of the respective periods T_{c}, and times of delay corresponding to the respective reference times are delay times T_{d1}, T_{d2}, T_{d3}, . . . . The detector 120 receives pulse light delayed from such a reference time by a predetermined time. The lengths of the delay times T_{d1}, T_{d2}, T_{d3}, . . . may be, for example, integer multiples of the pulse width Tₚ of pulse light in the carrier wave. In the example illustrated in FIG. 24, T_{d1} is Tₚ, T_{d2} is 2×Tₚ, and T_{d3} is 3×Tₚ. The length of the delay time T_{d4} is equal to the length of the delay time T_{d2}, and the length of the delay time T_{d5} is equal to the length of the delay time T_{d1}. Thus, the delay time of pulse light in the carrier wave may be set to discretely change at steps with the pulse width Tₚ as the unit time. The length of each delay time is not limited to an integer multiple of the pulse width Tₚ but may be any length in a range with which pulse light is received in the exposure period of the variable sensitivity pixel.

As illustrated in (b) in FIG. 24, the light receiving sensitivity (sensitivity α_{A}) of the photoelectrical conversion unit 13 of the variable sensitivity pixel is set by the control unit 130 to repeatedly change in a period equal to the period T_{c}, which is the interval between reference times for emission of pulse light of the carrier wave. In the example illustrated in FIG. 24, the variable sensitivity pixel is set to the sensitivity α₀ at time points T₀₁, T₀₂, T₀₃, . . . as reference time. The variable sensitivity pixel is set to the sensitivity α₁ in the second period starting after a time equal to the pulse width Tₚ elapses since each reference time and having a length equal to the pulse width Tₚ. The variable sensitivity pixel is set to the sensitivity α₂ in the third period starting after a time two times longer than the pulse width Tₚ elapses since each reference time and having a length equal to the pulse width Tₚ. The variable sensitivity pixel is set to the sensitivity as in the fourth period starting after a time three times longer than the pulse width Tₚ elapses since each reference time and having a length equal to the pulse width Tₚ. The start time of the second period does not need to be after a predetermined time elapses since a reference time, but is set to be after the reference time in accordance with the delay time of pulse light emitted by the transmission device 200.

Change of the light receiving sensitivity of the variable sensitivity pixel may be achieved by change of the value of voltage applied to the counter electrode 12 as illustrated in FIG. 5 above or may be achieved by forming pulses of voltage applied to the counter electrode 12 and changing the duty cycle thereof as illustrated in FIG. 14. The operation of the distance measurement device according to Embodiments 1 to 4 described above is also applicable to the phase detection device 100A. For example, (b) in FIG. 24 only illustrates temporal change of the light receiving sensitivity of the variable sensitivity pixel in Embodiments 1 to 4 described above, but similarly to the embodiments described above, a fixed sensitivity pixel having constant light receiving sensitivity in the charge accumulation period and/or an offset pixel may be disposed in the detector 120. Operation for measurement of the delay time T_{d} by using the fixed sensitivity pixel and/or the offset pixel is the same as described above, and thus description thereof is omitted.

As illustrated in (c) in FIG. 24, electric charge accumulation and pixel reading at the variable sensitivity pixel are repeatedly performed in the period T_{c} in synchronization with repeated emission of pulse light of the carrier wave based on each reference time in the period T_{c}.

As illustrated in (d) in FIG. 24, a signal that has a signal level in accordance with the amount of electric charge accumulated in the charge accumulation period and is read in the above-described pixel reading period is output from the phase detection device 100A. In (d) in FIG. 24, for sake of simplicity, a detected signal level changes in the pixel reading period in (c) in FIG. 24 and the output level is held until the next signal reading period after the period T_{c}, but a signal output from the phase detection device 100A according to the present embodiment is not limited to such an example. Holding of the output level may be performed by the detector 120 or the phase detection unit 150A.

In the period of one period starting at time point T₀₁ in FIG. 24, pulse light of the carrier wave is emitted at a time point delayed from time point T₀₁ by the delay time T_{d1} (=Tₚ). In this case, the light receiving sensitivity of the photoelectrical conversion unit 13 of the variable sensitivity pixel in the phase detection device 100A according to the present embodiment is α₁, and thus an output signal level obtained from the phase detection device 100A in this case is α₁S. The letter S represents an output signal level obtained when the light receiving sensitivity of the photoelectrical conversion unit 13 is one. Similarly, in the period of one period starting at time point T₀₂, pulse light of the carrier wave is emitted at a time point delayed from time point T₀₂ by the delay time T_{d2} (=2×Tₚ), and since the light receiving sensitivity of the photoelectrical conversion unit 13 in this case is α₂, an output signal level obtained from the phase detection device 100A is α₂S. The same argument is applicable to the period of one period starting at the reference time at time point T₀₃ or later.

As illustrated in (c) in FIG. 24, in the phase detection device 100A according to the present embodiment, the light receiving sensitivity of the photoelectrical conversion unit 13 of the variable sensitivity pixel is higher as a delay time since a reference time (time point T₀₁, T₀₂, T₀₃, . . . ) is longer. In the example illustrated in FIGS. 23 and 24, pulse light of the carrier wave is emitted such that the above-described delay time since a reference time is longer as the signal level of transmission data is higher, and thus when such operation is performed, the signal level of the original transmission data is restored as the magnitude relation of an output signal from the phase detection device 100A. Accordingly, the phase detection device 100A outputs a signal having a signal level of the magnitude corresponding to the delay time since a reference time. In this manner, when the sensitivity of the variable sensitivity pixel is set for outputting at a signal level of the magnitude corresponding to the delay time, the carrier wave can be easily restored as the transmission data.

Before signal transmission is started, handshake communication may be performed between the transmission device 200 and the phase detection device 100A to align time points (such as time points T₀₁, T₀₂, . . . in FIG. 24) as references for sending of the carrier wave, and data transmission and reception may be started once the reference times are aligned between the transmitting side and the receiving side. Information indicating the reference times may be included in a part of the carrier wave, for example, an initial part of the carrier wave or may be transmitted from the transmission device 200 to the phase detection device 100A by a signal different from the carrier wave. The above-described interval of reference times is constant but does not necessarily need to be constant when the reference time of each pulse light can be set by, for example, sending a signal indicating the reference time.

The phase detection device 100A outputs, as a phase detection result, a signal in which the signal level of the transmission data is restored, but is not limited to this configuration. The phase detection device 100A (the phase detection unit 150A of the phase detection device 100A) may calculate a delay time (phase difference) by the same method as that for the distance measurement device 100 and may output data indicating a result of the calculated delay time. Restoration of the transmission data by using the calculated delay time may be performed by an external device, or the restoration may be performed by the phase detection unit 150A and a result of the restoration may be output from the phase detection unit 150A.

As described above, similarly to the distance measurement device 100, the phase detection device 100A according to the present embodiment can output a signal in accordance with a delay time without distributing signal charge to two charge accumulation parts. Accordingly, the phase detection device 100A does not cause incomplete distribution of signal charge and thus can output a phase detection result at high accuracy. For this reason, the phase detection device 100A is applicable as, for example, a reception device in optical data communication using phase modulation.

Similarly to the above description with reference to FIGS. 12A and 12B, the phase detection device 100A can expand the range of a delay time with which measurement can be performed without accuracy degradation for the same pulse width Tₚ as compared to a case in which a delay time is calculated by a charge distribution scheme. Thus, for example, when the phase detection device 100A is used in the above-described optical data communication, the range of the amplitude of a transmitted signal that is converted into carrier wave and transmitted can be increased.

### OTHER EMBODIMENTS

The distance measurement device and the phase detection device according to the present disclosure are described above based on the embodiments, but the present disclosure is not limited to the embodiments.

For example, processing executed by a particular processing unit in the above-described embodiments may be executed by any other processing unit. The order of a plurality of pieces of processing may be changed, and a plurality of pieces of processing may be executed in parallel.

Each constituent component in the above-described embodiments may be implemented by executing a software program suitable for the constituent component. Each constituent component may be implemented by a program execution unit such as a CPU or a processor reading and executing a software program recorded in a recording medium such as a hard disk or a semiconductor memory.

Each constituent component may be implemented by hardware. Each constituent component may be a circuit (or integrated circuit). Such circuits may constitute one circuit as a whole or may be separate circuits. The circuits may be each a general-purpose circuit or a dedicated circuit.

Any general or specific aspect of the present disclosure may be implemented by a system, a device, a method, an integrated circuit, a computer program, or a computer-readable recording medium such as a CD-ROM. Alternatively, any general or specific aspect of the present disclosure may be implemented by optional combination of a system, a device, a method, an integrated circuit, a computer program, and a recording medium.

For example, the present disclosure may be implemented as the distance measurement device of each above-described embodiment, may be implemented as a computer program for causing a computer to execute a distance measurement method performed by a processing unit, or may be implemented as a non-transitory computer-readable recording medium in which such a computer program is recorded.

Other embodiments and examples provided with various kinds of deformation that could be thought of by the skilled person in the art and any other form established by combining some constituent components in the embodiments and examples are included in the range of the present disclosure without deviation from the gist of the present disclosure.

The distance measurement device, the phase detection device, and any other configuration according to the present disclosure are applicable to various usages such as an optical data communication reception device, a distance measurement system, and a distance sensing system.

What is claimed is:

1. A distance measurement device comprising:
a projector that projects pulse light toward an object;
a detector that receives reflected light of the pulse light from the object, the detector including a first pixel having sensitivity that is variable; and
a control circuit, wherein
the projector projects first pulse light in a first period, and
the control circuit sets the sensitivity of the first pixel to first sensitivity in a second period and sets the sensitivity of the first pixel to second sensitivity different from the first sensitivity in a third period following the second period, a length of the second period being equal to a length of the first period, a start time of the second period being after a start time of the first period, the second period and the third period being included in a first light-reception period.

2. The distance measurement device according to claim 1, wherein the first sensitivity and the second sensitivity are constant in the second period and the third period, respectively.

3. The distance measurement device according to claim 1, wherein the first sensitivity and the second sensitivity linearly increase in the second period and the third period respectively or linearly decrease in the second period and the third period respectively.

4. The distance measurement device according to claim 1, wherein
the first light-reception period includes the second period, the third period, and a fourth period following the third period,
the control circuit sets the sensitivity of the first pixel to third sensitivity in the fourth period, the third sensitivity being different from the first sensitivity and the second sensitivity,
a length of the third period is equal to the length of the first period, and
the second sensitivity is sensitivity between the first sensitivity and the third sensitivity.

5. The distance measurement device according to claim 4, wherein the first sensitivity, the second sensitivity, and the third sensitivity are constant in the second period, the third period, and the fourth period, respectively.

6. The distance measurement device according to claim 4, wherein in the first light-reception period, the first sensitivity, the second sensitivity, and the third sensitivity linearly increase in the second period, the third period, and the fourth period respectively or linearly decrease in the second period, the third period, and the fourth period respectively.

7. The distance measurement device according to claim 1, wherein
the detector includes a second pixel, and
the control circuit sets, in the first light-reception period, sensitivity of the second pixel to reference sensitivity for distance measurement.

8. The distance measurement device according to claim 1, wherein
the detector includes a third pixel,
the control circuit sets, in a non-light-reception period following the first light-reception period, the sensitivity of the first pixel to basis sensitivity lower than the sensitivity of the first pixel in the first light-reception period, and
the control circuit sets sensitivity of the third pixel to the basis sensitivity in the first light-reception period.

9. The distance measurement device according to claim 1, wherein
the projector projects second pulse light in a fifth period having a length equal to the length of the first period, and
the control circuit sets the sensitivity of the first pixel to reference sensitivity for distance measurement in a second light-reception period, a length of the second light-reception period being equal to a length of the first light-reception period, a start time of the second light-reception period being after a start time of the fifth period.

10. The distance measurement device according to claim 1, wherein
the projector projects third pulse light in a sixth period having a length equal to the length of the first period,
the control circuit sets, in a non-light-reception period following the first light-reception period, the sensitivity of the first pixel to basis sensitivity lower than the sensitivity of the first pixel in the first light-reception period, and
the control circuit sets the sensitivity of the first pixel to the basis sensitivity in a third light-reception period, a length of the third light-reception period being equal to a length of the first light-reception period, a start time of the third light-reception period being after a start time of the sixth period.

11. The distance measurement device according to claim 1, wherein
the first pixel includes a photoelectrical convertor, and
the control circuit sets the sensitivity of the first pixel by adjusting a magnitude of voltage applied to the photoelectrical convertor.

12. The distance measurement device according to claim 1, wherein
the first pixel includes a photoelectrical convertor, and
the control circuit sets the sensitivity of the first pixel by adjusting a duty cycle of pulse voltage that is applied to the photoelectrical convertor and that alternately repeats first voltage and second voltage larger than the first voltage.

13. A distance measurement method comprising:
projecting first pulse light toward an object in a first period;
detecting reflected light of the first pulse light from the object at first sensitivity in a second period; and
detecting the reflected light of the first pulse light from the object at second sensitivity different from the first sensitivity in a third period following the second period, a length of the second period being equal to a length of the first period, a start time of the second period being after a start time of the first period, the second period and the third period being included in a first light-reception period.

14. The distance measurement method according to claim 13, further comprising
detecting, in the first light-reception period, the reflected light at reference sensitivity for distance measurement.

15. The distance measurement method according to claim 13, further comprising
projecting second pulse light toward the object in a fifth period having a length equal to the length of the first period, and
detecting reflected light of the second pulse light from the object at reference sensitivity for distance measurement in a second light-reception period, a length of the second light-reception period being equal to a length of the first light-reception period, a start time of the second light-reception period being after a start time of the fifth period.

16. A phase detection device comprising:
a detector that receives pulse light delayed for a predetermined time from a reference time, the detector including a first pixel having sensitivity that is variable; and
a control circuit, wherein
the control circuit sets the sensitivity of the first pixel to first sensitivity in the second period and sets the sensitivity of the first pixel to second sensitivity different from the first sensitivity in a third period following the second period, a length of the second period being equal to a pulse width of the pulse light, a start time of the second period being after the reference time, the second period and the third period being included in a first light-reception period.
